(19) United States
(12) Patent Application Publication
(10) Pub. No.: US 2026/0009944 A1
(43) Pub. Date: Jan. 8, 2026

(54) LIGHTING DEVICE, DISPLAY DEVICE, METHOD OF MANUFACTURING LIGHTING DEVICE, AND METHOD OF MANUFACTURING DISPLAY DEVICE

(71) Applicant: Sharp Display Technology Corporation, Kameyama City (JP)

(72) Inventor: Chikashi Fukuyama, Kameyama City (JP)

(21) Appl. No.: 19/241,497

(22) Filed: Jun. 18, 2025

(30) Foreign Application Priority Data
Jul. 5, 2024 (JP) 2024-108734

(51) Int. Cl. F21V 8/00

(52) U.S. Cl. CPC G02B 6/0088

(57) ABSTRACT

A chassis includes a bottom plate portion and a chassis side wall portion. A frame includes a main body frame portion and a frame side wall portion, and the frame side wall portion is disposed outside the chassis side wall portion to cover the chassis from the front side in a state where the main body frame portion overlaps at least part of the optical component. A backlight device further includes a fixing portion that is formed at least in part or the whole of a gap between the chassis side wall portion and the frame side wall portion and fixes the chassis and the frame, and the fixing portion is formed of a hot melt resin.

### CROSS REFERENCE TO RELATED APPLICATION

This application claims priority from Japanese Patent Application No. 2024-108734 filed on Jul. 5, 2024. The entire contents of the priority application are incorporated herein by reference.

### TECHNICAL FIELD

The present disclosure relates to a lighting device, a display device, a method of manufacturing the lighting device, and a method of manufacturing the display device.

### BACKGROUND

There has been known a liquid crystal device including a backlight unit. Such a backlight unit includes a case, an optical component disposed inside the case, and an elastic component fitted to a side wall portion of the case and in contact with the optical component. The side wall portion of a front bezel of the liquid crystal display device exists outside the side wall portion of the case. The outer portion of the elastic component is sandwiched between the inner face of the side wall portion of the front bezel and the outer face of the side wall portion of the case, comes into contact with the inner face of the side wall portion of the front bezel and the outer face of the side wall portion of the case, and presses the inner face of the side wall portion of the front bezel and the outer face of the side wall portion of the case in the in-plane direction of a display region. As a result, even when there is a gap between the case and the front bezel due to assembly tolerance, it is suppressed that the case and the front bezel come into contact with each other at the time of vibration to generate abnormal noise.

In the liquid crystal display device described above, since the elastic component is a dedicated component, there is a problem that the number of components of the liquid crystal display device increases. In addition, since there is a variation in the size of the gap between the parts due to the assembly tolerance, there may be a case where the occurrence of the abnormal noise cannot be suppressed even if the dedicated elastic component is used. In addition, since it is necessary to assemble each member so that the elastic component comes into contact with the inner face of the side wall portion of the front bezel and the outer face of the side wall portion of the case, there is a problem that the number of assembling steps increases, resulting in a new manufacturing cost.

### SUMMARY

The present disclosure has been completed based on the above circumstances, and an object of the present disclosure is to provide a lighting device, a display device, a method of manufacturing the lighting device, and a method of manufacturing the display device capable of easily suppressing occurrence of abnormal noise at the time of vibration at low cost even when there is a variation in size of a gap between parts due to assembly tolerance.

A lighting device of the present disclosure includes a chassis that is opened toward a front side and inside which a sheet-like optical component is disposed, and a frame that covers the chassis from the front side, wherein the chassis includes a bottom plate portion and a chassis side wall portion rising from an outer peripheral end portion of the bottom plate portion toward the front side, wherein the frame includes a main body frame portion and a frame side wall portion falling from an outer peripheral end portion of the main body frame portion toward a back side, and covers the chassis from the front side, the frame side wall portion being disposed outside the chassis side wall portion in a state where the main body frame portion overlaps at least part of the optical component, wherein the lighting device further includes a fixing portion that is formed in part or a whole of a gap formed at least between the chassis side wall portion and the frame side wall portion and that fixes the chassis and the frame, and wherein the fixing portion is formed of a hot melt resin.

According to the present disclosure, even when there is a variation in size of a gap between parts due to assembly tolerance, occurrence of abnormal noise at the time of vibration can be easily suppressed at low cost.

### BRIEF DESCRIPTION OF THE DRAWINGS

FIG. 1 is a horizontal cross-sectional view of a backlight device according to a first embodiment.

FIG. 2 is a cross-sectional view taken along line A-A of FIG. 1.

FIG. 3 is a cross-sectional view taken along line B-B in FIG. 1.

FIG. 4 is a flowchart illustrating a method of manufacturing a lighting device.

FIG. 5A illustrates a part of a manufacturing step of a backlight device with reference to a cross-sectional view taken along line B-B in FIG. 1.

FIG. 5B illustrates a part of the manufacturing step of the backlight device with reference to the cross-sectional view taken along line B-B in FIG. 1.

FIG. 5C illustrates a part of the manufacturing step of the backlight device with reference to the cross-sectional view taken along line B-B in FIG. 1.

FIG. 6A illustrates a part of the manufacturing step of the backlight device with reference to the cross-sectional view taken along line B-B in FIG. 1.

FIG. 6B illustrates a part of the manufacturing step of the backlight device with reference to the cross-sectional view taken along line B-B in FIG. 1.

FIG. 6C illustrates a part of the manufacturing step of the backlight device with reference to the cross-sectional view taken along line B-B in FIG. 1.

FIG. 7 is a cross-sectional view of a portion of a backlight device according to a second embodiment corresponding to a portion taken along line B-B in FIG. 1.

FIG. 8 is a cross-sectional view of a portion of a modification of the backlight device of the second embodiment corresponding to a portion taken along line B-B in FIG. 1.

FIG. 9 is a cross-sectional view of a portion of a backlight device according to a third embodiment corresponding to a portion taken along line B-B in FIG. 1.

FIG. 10 is a cross-sectional view of a portion of a display device according to a fourth embodiment corresponding to a portion taken along line A-A in FIG. 1.

FIG. 11 is a cross-sectional view of a portion of the display device according to the fourth embodiment corresponding to a portion taken along line C-C in FIG. 1.

FIG. 12 is a flowchart illustrating a method of manufacturing the display device.

FIG. 13A illustrates a part of a manufacturing step of a liquid crystal display device with reference to a cross-sectional view taken along line B-B in FIG. 1.

FIG. 13B illustrates a part of the manufacturing step of the liquid crystal display device with reference to the cross-sectional view taken along line B-B in FIG. 1.

FIG. 13C illustrates a part of the manufacturing step of the liquid crystal display device with reference to the cross-sectional view taken along line B-B in FIG. 1.

FIG. 14A illustrates a part of the manufacturing step of the liquid crystal display device with reference to the cross-sectional view taken along line B-B in FIG. 1.

FIG. 14B illustrates a part of the manufacturing step of the liquid crystal display device with reference to the cross-sectional view taken along line B-B in FIG. 1.

FIG. 15 is a cross-sectional view of a portion of a liquid crystal display device according to a fifth embodiment corresponding to a portion taken along line B-B in FIG. 1.

FIG. 16 is a cross-sectional view of a portion of a modification of the liquid crystal display device according to the fifth embodiment corresponding to a portion taken along line B-B in FIG. 1.

FIG. 17A illustrates a part of a manufacturing step of a liquid crystal display device according to a sixth embodiment with reference to a cross-sectional view taken along the line C-C in FIG. 1.

FIG. 17B illustrates a part of the manufacturing step of the liquid crystal display device according to the sixth embodiment with reference to the cross-sectional view taken along the line C-C in FIG. 1.

FIG. 17C illustrates a part of the manufacturing step of the liquid crystal display device according to the sixth embodiment with reference to the cross-sectional view taken along the line C-C in FIG. 1.

### DETAILED DESCRIPTION

First, embodiments of the present disclosure will be listed and described.

(1) A lighting device of the present disclosure includes a chassis that is opened toward a front side and inside which a sheet-like optical component is disposed, and a frame that covers the chassis from the front side, wherein the chassis includes a bottom plate portion and a chassis side wall portion rising from an outer peripheral end portion of the bottom plate portion toward the front side, wherein the frame includes a main body frame portion and a frame side wall portion falling from an outer peripheral end portion of the main body frame portion toward a back side, and covers the chassis from the front side, the frame side wall portion being disposed outside the chassis side wall portion in a state where the main body frame portion overlaps at least part of the optical component, wherein the lighting device further includes a fixing portion that is formed in part or a whole of a gap formed between the chassis side wall portion and the frame side wall portion and that fixes the chassis and the frame, and wherein the fixing portion is formed of a hot melt resin.

A size of a gap formed between the chassis side wall portion and the frame side wall portion may vary due to assembly tolerance. The hot melt resin has fluidity at the time of use (at the time of manufacturing a lighting device). Therefore, the fixing portion can appropriately fill the gap formed between the chassis side wall portion and the frame side wall portion according to the size of the gap. In this way, since the fixing portion can fix the chassis and the frame, it is not necessary to provide a dedicated component for filling a gap between the chassis side wall portion and the frame side wall portion. Therefore, the lighting device according to the present disclosure can easily suppress the occurrence of the abnormal noise at the time of vibration at low cost even if the size of the gap between the parts varies due to the assembly tolerance.

(2) In the lighting device according to (1), the gap between the chassis side wall portion and the frame side wall portion may widen from the front side to the back side.

In this case, the hot melt resin is easily injected from the back side into the gap between the chassis side wall portion and the frame side wall portion. Therefore, since the chassis and the frame are more appropriately fixed by the fixing portion, the occurrence of abnormal noise is further suppressed.

(3) In the lighting device according to (1) or (2), a first recess that is recessed toward the front side may be formed in a portion of the main body frame portion, the portion being close to the front side end portion of the chassis side wall portion.

By forming the first recess in the body frame portion, contact between the front side end portion of the chassis side wall portion of the chassis covered by the frame and the main body frame portion of the frame is suppressed. In addition, the hot melt resin with which the gap between the chassis side wall portion and the frame side wall portion is filled easily flows into and accumulates in the first recess. Therefore, a fixing portion that fixes the chassis and the frame is also formed between the front side end portion of the chassis side wall portion and the main body frame portion of the frame. Therefore, since the chassis and the frame are more appropriately fixed, the occurrence of abnormal noise is further suppressed.

(4) A display device of the present disclosure includes the lighting device according to (1) to (3), and a display panel that displays an image using light emitted from the lighting device.

According to the display device having such a configuration, since the occurrence of abnormal noise in the lighting device that irradiates the display panel with light is suppressed at low cost, manufacturing cost is reduced.

(5) A display device of the present disclosure includes a display panel, a bezel covering the display panel from a front side, and a lighting device disposed on a back side of the display panel, wherein the bezel includes an edge portion surrounding a display region of the display panel on the front side of the display panel, and a bezel side wall portion falling from an outer peripheral end portion of the edge portion toward the back side, wherein the lighting device includes a chassis that is opened toward the front side and inside which a sheet-like optical component is disposed, and a frame that covers the chassis from the front side, wherein the frame includes a main body frame portion and a frame side wall portion falling from an outer peripheral end portion of the main body frame portion toward the back side, and covers the chassis from the front side, the frame side wall portion being disposed outside the chassis side wall portion in a state where the main body frame portion overlaps at least part of the optical component, the bezel side wall portion being disposed outside the frame side wall portion, wherein the lighting device further includes a fixing portion that is formed in part or a whole of a gap formed between the bezel side wall portion and the frame side wall portion and fixes the bezel and the frame, and wherein the fixing portion is formed of a hot melt resin.

The size of the gap formed between the frame side wall portion and the bezel side wall portion may vary due to assembly tolerance. The hot melt resin has fluidity at the time of use (at the time of manufacturing a display device). Therefore, the fixing portion can appropriately fill the gap between the frame side wall portion and the bezel side wall portion in accordance with the size of the gap. In this way, since the fixing portion can fix the frame and the bezel, it is not necessary to provide a dedicated component for filling the gap between the frame side wall portion and the bezel side wall portion. Therefore, the display device according to the present disclosure can easily suppress the occurrence of the abnormal noise at the time of vibration at low cost even if the size of the gap between the parts varies due to the assembly tolerance.

(6) In the display device according to (5), a frame outer face that is an outer face of the frame side wall portion and a bezel inner face that is an inner face of the bezel side wall portion may face each other in an inclined manner.

In this case, the display device can secure a gap between the frame outer face and the bezel inner face to further widen a region where the fixing portion can be formed. Therefore, since the frame and the bezel are more appropriately fixed by the fixing portion, the occurrence of abnormal noise is further suppressed.

(7) In the display device according to (5) or (6), the bezel side wall portion may include an opening formed to penetrate the bezel side wall portion in a portion disposed outside the frame side wall portion. In a state in which the display panel and the lighting device covered with the bezel are assembled, a second recess recessed inward may be formed at a position at which the second recess overlaps the opening of the bezel side wall portion in a portion of the frame side wall portion disposed inside the bezel side wall portion. The fixing portion may be formed so as to close the second recess and the opening.

By forming the opening in the bezel side wall portion and forming the second recess in the frame side wall portion, an operator can inject the hot melt resin from the opening toward the second recess. The injected hot melt resin is accumulated in the second recess, and the accumulated hot melt resin closes the opening to form a fixing portion, so that the bezel and the frame are fixed. In this case, even when the bezel side wall portion and the frame side wall portion are formed to be thin, the fixing portion can be formed in part of the gap, and the bezel and the frame can be fixed by the fixing portion. Therefore, it is possible to provide a display device with excellent appearance in which the occurrence of abnormal noise is suppressed and the width of the edge portion of the bezel is further narrowed.

(8) A method of manufacturing a lighting device according to the present disclosure includes: a chassis preparation step of disposing a sheet-like optical component inside a chassis that is opened toward a front side, the chassis including a bottom plate portion and a chassis side wall portion rising from an outer peripheral end portion of the bottom plate portion toward the front side; a frame preparation step of preparing a frame including a main body frame portion and a frame side wall portion falling from an outer peripheral end portion of the main body frame portion toward a back side; a lighting device assembling step of covering the chassis with the frame from the front side so that the frame side wall portion is disposed outside the chassis side wall portion in a state where the main body frame portion overlaps at least part of the optical component; and a hot melt resin disposing step of disposing a hot melt resin in part or a whole of a gap formed at least between the chassis side wall portion and the frame side wall portion.

A size of a gap formed between the chassis side wall portion and the frame side wall portion may vary due to assembly tolerance. Since the hot melt resin has fluidity at the time of use (at the time of manufacturing the lighting device), the gap can be appropriately filled according to the size of the gap formed between the chassis side wall portion and the frame side wall portion. The hot melt resin with which the gap is filled is cured later, whereby the chassis and the frame are fixed to each other. Therefore, it is not necessary to provide a dedicated component for filling the gap between the chassis side wall portion and the frame side wall portion. Therefore, the method of manufacturing the lighting device according to the present disclosure can easily suppress the occurrence of the abnormal noise at the time of vibration at low cost even if the size of the gap between the parts varies due to the assembly tolerance.

(9) In the method according to (8), the frame preparation step may include performing forming so that a frame inner face that is an inner face of the frame side wall portion is inclined with respect to the main body frame portion, or the chassis preparation step may include performing forming so that a chassis outer face that is an outer face of the chassis side wall portion is inclined with respect to the bottom plate portion. The gap between the chassis side wall portion and the frame side wall portion may be formed to widen from the front side toward the back side when the frame covers the chassis from the front side in the lighting device assembling step.

In this case, the hot melt resin is easily injected from the back side into the gap between the chassis side wall portion and the frame side wall portion. Therefore, since the chassis and the frame are more appropriately fixed, the occurrence of abnormal noise is further suppressed.

(10) In the method according to (8) or (9), the frame preparation step may include forming a first recess recessed toward the front side in a portion of the main body frame portion, the portion being close to the front side end portion of the chassis side wall portion.

By forming the first recess in the body frame portion, contact between the front side end portion of the chassis side wall portion of the chassis covered by the frame and the main body frame portion of the frame is suppressed. In addition, the hot melt resin with which the gap between the chassis side wall portion and the frame side wall portion is filled easily flows into and accumulates in the first recess. Therefore, the hot melt resin is disposed between the front side end portion of the chassis side wall portion and the main body frame portion of the frame. Therefore, since the chassis and the frame are more appropriately fixed, the occurrence of abnormal noise is further suppressed.

(11) A method of manufacturing a display device of the present disclosure includes a step of mounting a lighting device manufactured by the method according to (8) to (10) on a display panel that displays an image using light emitted from the lighting device.

According to such a method of manufacturing a display device, since the occurrence of abnormal noise in the lighting device that irradiates the display panel with light is suppressed at low cost, the manufacturing cost is reduced.

(12) A method of manufacturing a display device according to the present disclosure includes: a chassis preparation step of preparing a chassis that is opened toward a front side and inside which a sheet-like optical component is disposed; a frame preparation step of preparing a frame including a main body frame portion and a frame side wall portion falling from an outer peripheral end portion of the main body frame portion toward a back side; a lighting device assembling step of assembling a lighting device by covering the chassis with the frame from the front side so that the frame side wall portion is disposed outside the chassis side wall portion in a state where the main body frame portion overlaps at least part of the optical component; a bezel preparation step of preparing a bezel including an edge portion surrounding a display region of a display panel and a bezel side wall portion falling from an outer peripheral end portion of the edge portion toward the back side; a display device assembling step of disposing the front side of the lighting device on the back side of the display panel, and assembling the display panel to the lighting device so that the bezel side wall portion is disposed outside the frame side wall portion in a state where the edge portion of the bezel overlaps a portion surrounding the display region of the display panel; and a hot melt resin disposing step of disposing a hot melt resin in part or a whole of a gap formed at least between the bezel side wall portion and the frame side wall portion.

The size of the gap formed between the frame side wall portion and the bezel side wall portion may vary due to assembly tolerance. Since the hot melt resin has fluidity at the time of use (at the time of manufacturing the display device), the gap can be appropriately filled according to the size of the gap formed between the frame side wall portion and the bezel side wall portion. The hot melt resin with which the gap is filled is cured later, whereby the frame and the bezel are fixed to each other. Thus, it is not necessary to provide a dedicated component for filling the gap between the frame side wall portion and the bezel side wall portion. Therefore, the method of manufacturing the display device according to the present disclosure can easily suppress the occurrence of the abnormal noise at the time of vibration at low cost even if the size of the gap between the parts varies due to the assembly tolerance.

(13) In the method according to (12), in the frame preparation step, a frame outer surface that is an outer surface of the frame side wall portion is formed to be inclined with respect to the main body frame portion, or in the bezel preparation step, a bezel inner surface that is an inner surface of the bezel side wall portion is formed to be inclined with respect to the edge portion.

In this case, a gap between the frame outer face and the bezel inner face is secured. Therefore, since the frame and the bezel are more appropriately fixed, the occurrence of abnormal noise is further suppressed.

(14) In the method according to (12) or (13), the bezel preparation step may include forming an opening penetrating the bezel side wall portion in the bezel side wall portion. The frame preparation step may include forming a second recess recessed inward at a position at which the second recess overlaps the opening of the bezel side wall portion in a portion of the frame side wall portion disposed inside the bezel side wall portion when the display panel is assembled to the lighting device in the display device assembling step. The hot melt resin disposing step may include injecting a hot melt resin from the opening toward the second recess.

By forming the opening in the bezel side wall portion and forming the second recess in the frame side wall portion, an operator can inject the hot melt resin from the opening toward the second recess. The injected hot melt resin is accumulated in the second recess, and the accumulated hot melt resin closes the opening to form a fixing portion, so that the bezel and the frame are fixed. In this case, even when the bezel side wall portion and the frame side wall portion are formed to be thin, the fixing portion can be formed in part of the gap, and the bezel and the frame can be fixed by the fixing portion. Therefore, it is possible to provide a display device with excellent appearance in which the occurrence of abnormal noise is suppressed and the width of the edge portion of the bezel is further narrowed.

### Details of First Embodiment of Present Disclosure

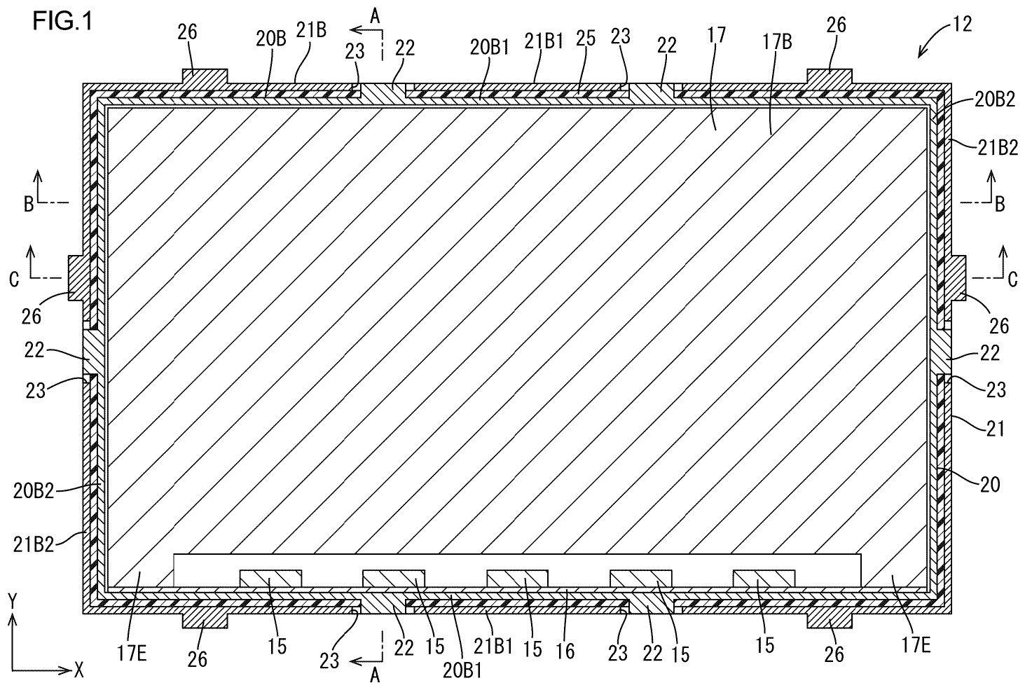

A schematic configuration of a backlight device 12 according to a first embodiment of the present disclosure will be described with reference to FIGS. 1 to 3. In the present specification, the backlight device 12 and a liquid crystal display device 10 using the backlight device 12 are exemplified. The backlight device 12 is an example of a lighting device. The backlight device 12 irradiates a liquid crystal panel 11 included in the liquid crystal display device 10 with light. The liquid crystal panel 11 is an example of the display panel. The liquid crystal display device 10 is an example of the display device. The liquid crystal display device 10 is preferably mounted on a vehicle. Specifically, the liquid crystal display device 10 is used to display a map image, an image captured by an in-vehicle camera, and the like in a car navigation system, and display various instruments such as a speedometer and a tachometer, various warning images such as an airbag warning lamp, an engine warning lamp, and a seatbelt non-wearing warning lamp, and the like in an instrument panel.

Note that the present disclosure is not limited to these examples, but is indicated by the claims, and is intended to include all modifications within the meaning and scope equivalent to the claims. In the following description, with respect to a plurality of the same members, only some members are denoted by reference numerals, and reference numerals of other members may be omitted. In part of each drawing, an X axis, a Y axis, and a Z axis are illustrated, and each axis direction is drawn to be the same direction illustrated in each drawing. In the Z axis, a direction in which the liquid crystal panel 11 is disposed is defined as a front side, and a direction in which the backlight device 12 is disposed is defined as a back side. In addition, in the present specification, “parallel” and “orthogonal” include an arrangement of a mode recognized as substantially parallel and orthogonal.

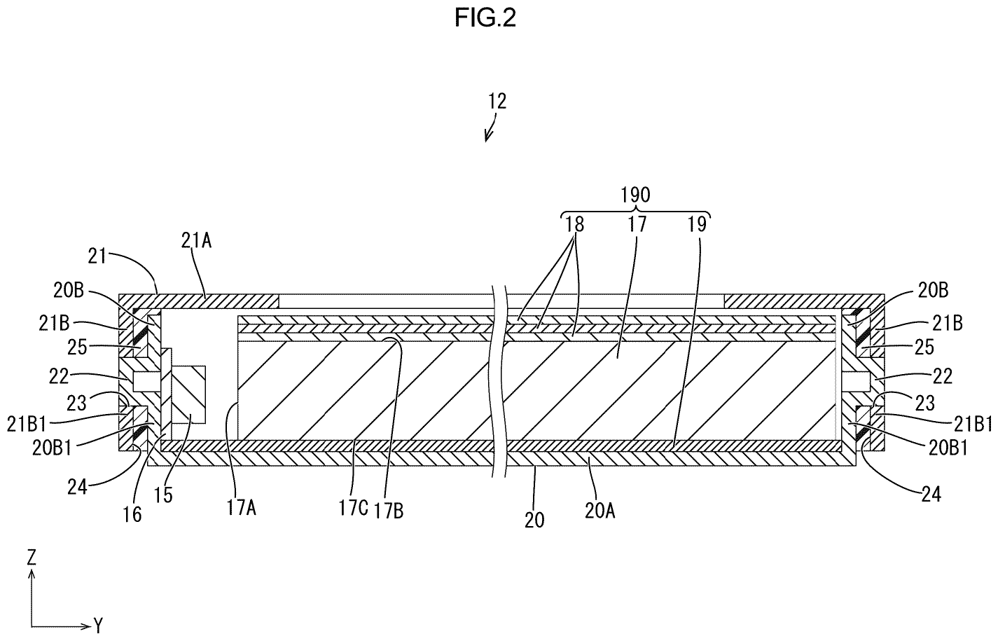

As illustrated in FIG. 1, the backlight device 12 has a horizontally long rectangular shape as a whole in plan view. As illustrated in FIGS. 1 to 3, the backlight device 12 includes a plurality of LEDs 15 as light sources, a light guide plate 17, an optical sheet 18 stacked and disposed on the front side of the light guide plate 17, a reflection sheet 19 stacked and disposed on the back side of the light guide plate 17, a tray-shaped chassis 20, and a frame-shaped frame 21. The backlight device 12 is of a one-side light-incident edge light type in which the light of the LEDs 15 is incident only from an end face corresponding to one long side, the end face being disposed on the lower side (left side illustrated in FIG. 2) illustrated in FIG. 1 of the outer peripheral end face of the light guide plate 17. However, the backlight device 12 may be a both-side light incident type in which the light of the LEDs 15 is incident from the end faces corresponding to both long sides of the light guide plate 17 (that is, the LEDs 15 are disposed along the end faces of both long sides of the light guide plate 17). In addition, the backlight device 12 may be configured to be incident (that is, the LEDs 15 are disposed along the end face corresponding to the short side of the light guide plate 17) from an end face corresponding to a short side of the light guide plate 17. The backlight device 12 may be a direct type in which the LEDs 15 are disposed at the back side of the light guide plate 17. In the present embodiment, a configuration in which the light of the LEDs 15 is incident from an end face corresponding to one long side of the light guide plate 17 will be exemplified.

As illustrated in FIGS. 1 to 3, the chassis 20 includes a bottom plate portion 20A having a horizontally long rectangular shape in plan view and extending in a planar shape, and a chassis side wall portion 20B rising from an outer peripheral end portion of the bottom plate portion 20A toward the front side and forming a short tubular shape, and has a tray shape opened toward the front side. The chassis 20 is made of a material having excellent rigidity, and is made of metal, for example. The LEDs 15, the light guide plate 17, the optical sheet 18, and the reflection sheet 19 are disposed inside the chassis 20 that is a region surrounded by the bottom plate portion 20A and the chassis side wall portion 20B. Hereinafter, the light guide plate 17, the optical sheet 18, and the reflection sheet 19, which are sheet-like optical components, are collectively referred to as an optical component 190.

As illustrated in FIGS. 1 and 2, the chassis side wall portion 20B is provided with a locking portion 22 that fixes the frame 21. The locking portion 22 is provided in a shape protruding outward from the outer face of the chassis side wall portion 20B. As illustrated in FIG. 1, one locking portion 22 is disposed near the central position of each of a pair of short side portions 20B2 in the length direction constituting the chassis side wall portion 20B, and two locking portions are disposed at two positions sandwiching the central position of each of a pair of long side portions 20B1 in the length direction.

As illustrated in FIGS. 1 and 2, the plurality of LEDs 15 is mounted on the mounting face of an LED substrate 16 extending along a light incident end face 17A of the light guide plate 17. The LED substrate 16 is attached to the chassis 20 in a state where a plate face opposite to the mounting face of the LEDs 15 is in contact with an inner face of the chassis side wall portion 20B of the chassis 20. On the mounting face of the LED substrate 16 for the LEDs 15, a wiring pattern (not illustrated) for supplying power to the LEDs 15 is patterned, and the plurality of LEDs 15 is mounted in a state of being disposed at intervals along the X axis direction. The LEDs 15 each have a rectangular parallelepiped shape, and are of a so-called top emission type in which a face opposite to a face mounted on the LED substrate 16 is a light emitting surface. The optical axis of each of the LEDs 15 (the traveling direction of light at which the emission intensity of the emission light is the highest) is the Y axis direction. The LEDs 15 may be of a monochromatic light emitting type or a white (mixed light) light emitting type. When the LEDs 15 are of a monochromatic light emitting type, white light may be emitted to the liquid crystal panel 11 by being used in combination with a wavelength conversion member. For example, a wavelength conversion sheet can be used for at least one optical sheet 18.

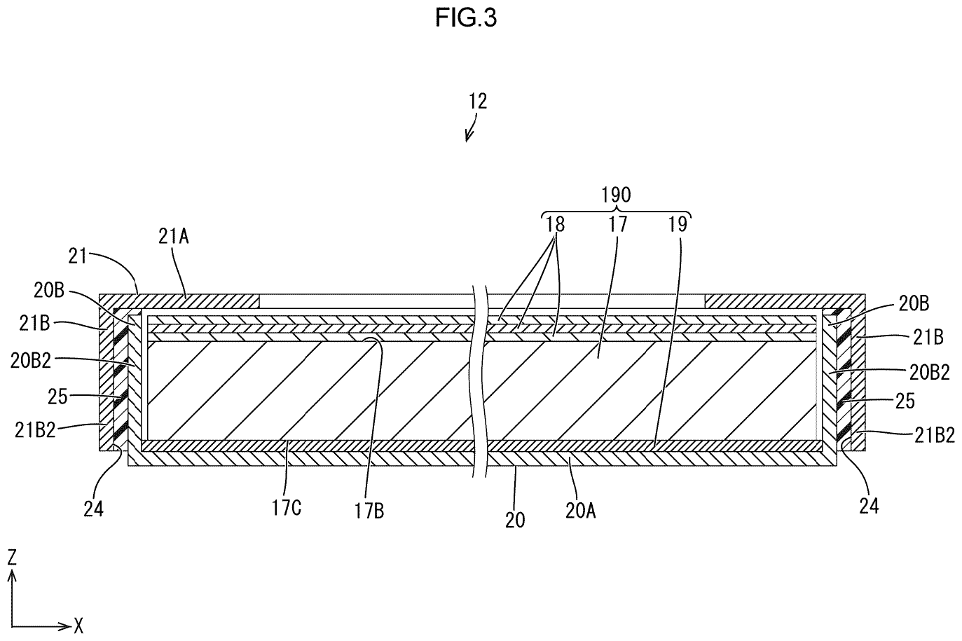

The light guide plate 17 guides light from the LEDs 15. The light guide plate 17 is made of a synthetic resin material that is substantially transparent and has a refractive index sufficiently higher than that of air. The synthetic resin constituting the light guide plate 17 is, for example, an acrylic resin such as PMMA or polycarbonate. As illustrated in FIGS. 2 and 3, the light guide plate 17 is disposed inside the chassis 20 in a state of being disposed at a position immediately below the optical sheet 18. As illustrated in FIG. 1, the light guide plate 17 has a horizontally long rectangular shape in plan view. The light guide plate 17 is disposed so that the above-described light incident end face 17A of the outer peripheral end face faces the LEDs 15. Of the pair of front and back plate faces of the light guide plate 17, the plate face facing the front side (liquid crystal panel 11 side) is a light emitting plate face 17B that emits light toward the liquid crystal panel 11, and the plate face facing the back side is an opposite-to-light-emitting plate face 17C opposite to the light emitting plate face 17B. With such a configuration, the light guide plate 17 has a function of introducing light emitted from the LEDs 15 along the Y axis direction from the light incident end face 17A, propagating the light inside, raising the light along the Z axis direction, and emitting the light from the light emitting plate face 17B toward the optical sheet 18 (front side, light emitting side).

As illustrated in FIG. 1, a pair of position regulators 17E protruding toward the LED substrate 16 is provided at both ends in the length direction (X axis direction) of the light incident end face 17A of the light guide plate 17. The pair of position regulators 17E is interposed between the light incident end face 17A of the light guide plate 17 and the LED substrate 16 and the chassis side wall portion 20B of the chassis 20, thereby regulating the positional relationship between the light incident end face 17A and the LEDs 15. As a result, even when thermal expansion occurs in the light guide plate 17, a situation in which the light incident end face 17A interferes with the LEDs 15 is avoided.

The optical sheet 18 imparts a predetermined optical effect to the light emitted from the light emitting plate face 17B of the light guide plate 17. As illustrated in FIGS. 2 and 3, the optical sheet 18 is disposed so that a plate face thereof is parallel to a plate face of the light guide plate 17 and the like and the optical sheet 18 covers the light emitting plate face 17B of the light guide plate 17. Various types of optical sheets 18 are known, and one or more types of optical sheets are used depending on the application or the like. For example, the optical sheet 18 is a light diffusion sheet, a prism sheet, a lens sheet, a luminance improvement sheet, or a wavelength conversion sheet made of resin. In a case where a plurality of the optical sheets 18 is used, the optical sheets 18 are stacked and installed on the light emitting plate face 17B. In the present embodiment, three optical sheets 18 are stacked on each other.

As illustrated in FIGS. 2 and 3, the reflection sheet 19 is disposed so that a plate face thereof is parallel to a plate face of the light guide plate 17 or the like and the reflection sheet 19 covers the opposite-to-light-emitting plate face 17C of the light guide plate 17. The reflection sheet 19 is excellent in light reflectivity, and can efficiently raise the light leaking from the opposite-to-light-emitting plate face 17C of the light guide plate 17 toward the front side (the light emitting plate face 17B). The reflection sheet 19 has an outer shape slightly larger than the light guide plate 17, and is disposed so that an end portion of one long side protrudes toward the LEDs 15 from the light incident end face 17A.

As illustrated in FIGS. 2 and 3, the frame 21 includes a main body frame portion 21A and a frame side wall portion 21B. The frame 21 is made of synthetic resin, but may be made of metal as in the chassis 20. The main body frame portion 21A has a horizontally long rectangular shape in plan view, and has a frame shape with a constant width in which the inner dimension of each side is smaller than the length of each side of the optical component 190 such as the light guide plate 17 and the outer dimension of each side is larger than the length of each side of the optical component 190. The main body frame portion 21A is disposed so as to overlap the outer peripheral end portion of the optical component 190 (directly, the optical sheet 18 on the most front side) from the front side, and covers the outer peripheral end portion of the optical component 190 from the front side over the entire circumference.

The frame side wall portion 21B is a portion that falls from the outer peripheral end portion of the main body frame portion 21A toward the back side (opposite to the light emission side) to form a short tubular shape. The frame side wall portion 21B is disposed outside chassis side wall portion 20B of chassis 20 (opposite to the inside of chassis 20). The frame side wall portion 21B surrounds the chassis side wall portion 20B so as to overlap the outside of the chassis side wall portion 20B, and is disposed so that the inner face of the frame side wall portion 21B faces the outer face of the chassis side wall portion 20B over the entire circumference. Between the inner face of the frame side wall portion 21B and the outer face of the chassis side wall portion 20B, a gap 24 for absorbing assembly tolerance between the frame 21 and the chassis 20 is provided. This ensures ease of assembly of the frame 21 to the chassis 20.

As illustrated in FIG. 2, the frame side wall portion 21B has an opening 23 for fixing the frame 21 to the chassis 20. The opening 23 is a through hole penetrating the frame side wall portion 21B along the plate thickness direction, and the locking portion 22 of the chassis 20 enters the opening and is locked to the back side portion of the opening edge. The opening 23 has an inner dimension larger than an outer dimension of the locking portion 22. As a result, even when a manufacturing error occurs in the locking portion 22 and the opening 23, the locking portion 22 reliably enters the opening 23, and the frame 21 is fixed to the chassis 20. In this manner, the optical component 190 accommodated inside the chassis 20 is held by being sandwiched from the back side and the front side in the Z axis direction by the chassis 20 and the frame 21.

As illustrated in FIG. 1, the arrangement of the opening 23 of the frame side wall portion 21B in the circumferential direction matches the arrangement of the locking portion 22 of the chassis side wall portion 20B in the circumferential direction. Specifically, one opening 23 is disposed near the central position of each of the pair of short side portions 21B2 constituting the frame side wall portion 21B in the length direction, and two openings 23 are disposed at two positions sandwiching the central position of each of the pair of long side portions 21B1 in the length direction.

The frame side wall portion 21B is provided with a locking portion 26 that fixes a bezel 30 of the liquid crystal display device 10 described later. The locking portion 26 is provided in a shape protruding outward from the outer face of the frame side wall portion 21B. As illustrated in FIG. 1, one locking portion 26 is disposed near the central position of each of the pair of short side portions 21B2 constituting the frame side wall portion 21B in the length direction, and two locking portions 26 are disposed at two positions sandwiching the central position of each of the pair of long side portions 21B1 in the length direction.

As illustrated in FIGS. 1 to 3, a fixing portion 25 is formed in the gap 24 formed between the frame side wall portion 21B and the chassis side wall portion 20B. The fixing portion 25 is formed by disposing a hot melt resin in the gap 24, and fixes the chassis 20 and the frame 21. The hot melt resin is a thermoplastic synthetic resin, and has a property of being liquefied when heated to about 90° C. to 100° C. There are various types of hot melt resins, and in the present embodiment, a moisture-curable resin that absorbs moisture in the air and cures is used.

As illustrated in FIGS. 2 and 3, the fixing portion 25 is provided so as to surround the entire outer face of the chassis side wall portion 20B over the entire gap 24, that is, between the frame side wall portion 21B and the chassis side wall portion 20B. As a result, even when vibration acts on the backlight device 12 when rattling due to assembly tolerance between the chassis 20 and the frame 21 or rattling due to a dimensional difference between the locking portion 22 and the opening 23 occurs, a situation in which the frame side wall portion 21B and the chassis side wall portion 20B come into contact with (interfere with) each other hardly occurs. Therefore, occurrence of abnormal noise (noise) due to contact between the frame side wall portion 21B and the chassis side wall portion 20B is suppressed. In addition, generation of foreign matter that is dust generated by part of the frame side wall portion 21B or part of the chassis side wall portion 20B being scraped due to contact between the frame side wall portion 21B and the chassis side wall portion 20B inside the backlight device 12 is suppressed.

In the first embodiment, the fixing portion 25 is also provided at a position between the front side end portion of the chassis side wall portion 20B and the back side of the main body frame portion 21A of the frame 21. Therefore, even when the length of the chassis side wall portion 20B in the Z axis direction and the length of the frame side wall portion 21B in the Z axis direction vary, a situation in which the front side end portion of the chassis side wall portion 20B and the back side of the main body frame portion 21A of the frame 21 come into contact with each other hardly occurs. Therefore, occurrence of abnormal noise and generation of foreign matter in the backlight device 12 are further suppressed. Specifically, since the liquid crystal display device 10 according to the present embodiment is mounted on a vehicle, vibration such as road noise may frequently act on the backlight device 12. In this respect, since the fixing portion 25 can suitably suppress the contact between the frame 21 and the chassis 20, noise in the vehicle interior space can be reduced.

Further, the fixing portion 25 can be provided by disposing a hot melt resin in the gap 24 between the existing frame side wall portion 21B and the existing chassis side wall portion 20B. That is, it is possible to suppress the contact between the frame side wall portion 21B and the chassis side wall portion 20B without newly designing a dedicated component for filling the gap 24 or changing the shapes or the like of the existing frame side wall portion 21B and the existing chassis side wall portion 20B in order to install the dedicated component in the gap 24. In a case where a dedicated component is provided, even in a case where the frame side wall portion 21B and the chassis side wall portion 20B are existing ones, a step of sandwiching the dedicated component between the frame side wall portion 21B and the chassis side wall portion 20B is required, and this step is assumed to take time and effort. In this respect, in the case of including the fixing portion 25, the number of components and the assembling steps are reduced as compared with the case of installing a dedicated component as in the related art, so that the cost can be reduced.

Note that the main body frame portion 21A need not cover the outer peripheral end portion corresponding to one side of the outer peripheral end portion of the optical component 190 from the front side, but may cover the outer peripheral end portions corresponding to the other three sides from the front side. Furthermore, the main body frame portion 21A may cover, from the front side, an outer peripheral end portion corresponding to a pair of opposing long sides or an outer peripheral end portion corresponding to a pair of opposing short sides of the outer peripheral end portions of the optical component 190. That is, it is sufficient that the frame 21 covers the chassis 20 from the front side by disposing the frame side wall portion 21B outside the chassis side wall portion 20B in a state where the main body frame portion 21A overlaps at least part of the optical component 190.

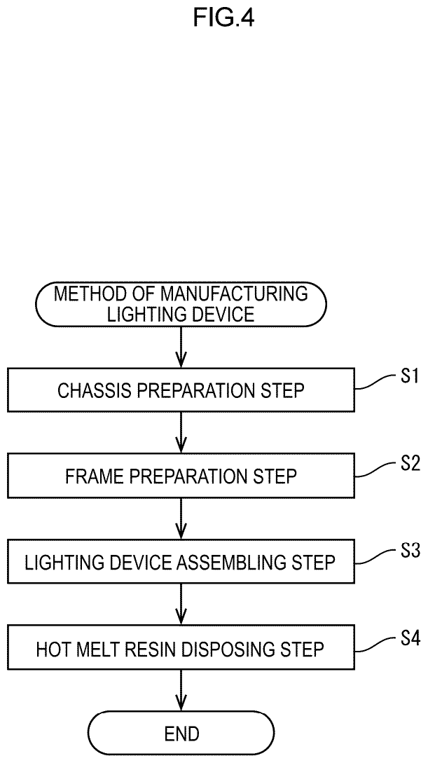

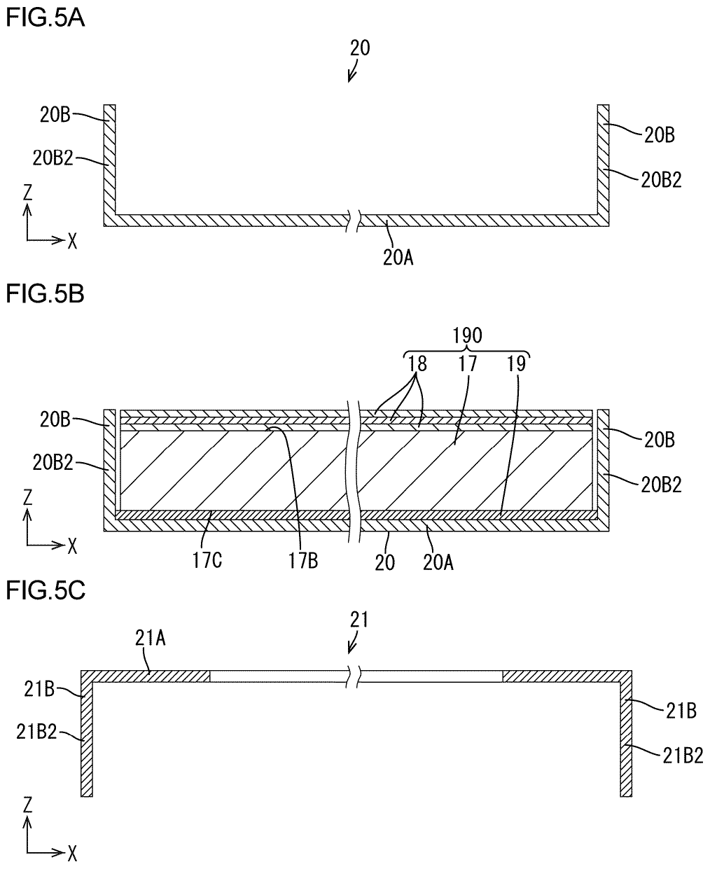

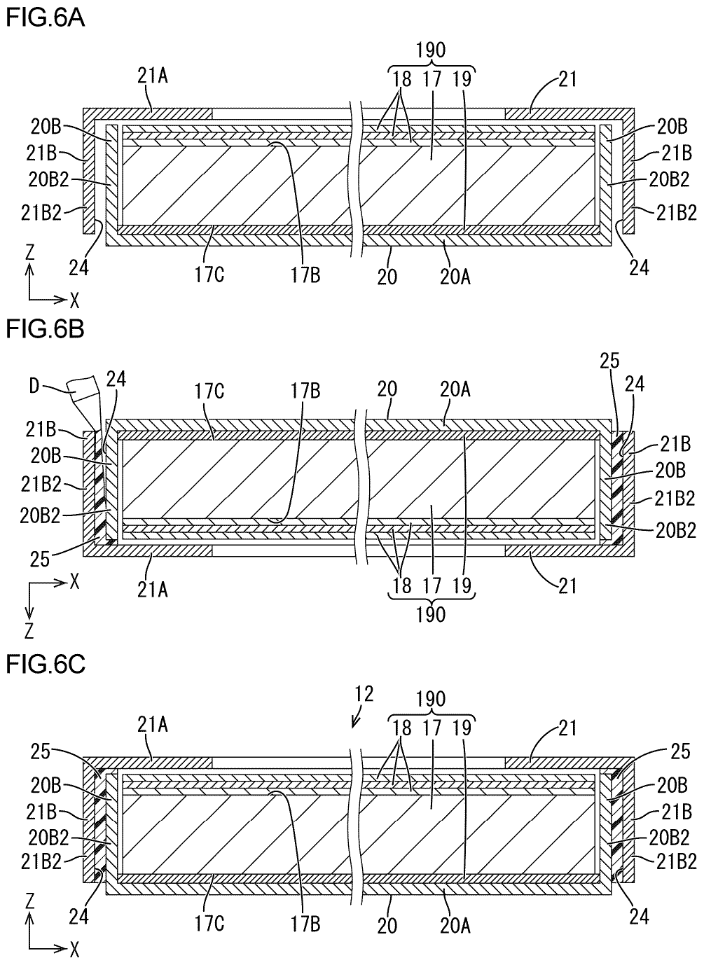

Next, a method of manufacturing the backlight device 12 will be described with reference to FIGS. 4 to 6. In the following description, each step of the method of manufacturing the backlight device 12 is abbreviated as “S”. As illustrated in FIG. 4, the method of manufacturing the backlight device 12 includes at least a chassis preparation step (S1), a frame preparation step (S2), a lighting device assembling step (S3), and a hot melt resin disposing step (S4). Each step will be described in order with reference to FIGS. 5A to 5C and FIGS. 6A to 6C.

In the chassis preparation step (S1), as illustrated in FIG. 5A, first, the chassis 20 is prepared. As described above, the chassis 20 includes the bottom plate portion 20A and the chassis side wall portion 20B. The bottom plate portion 20A and the chassis side wall portion 20B are formed by bending and raising the four circumferences of a sheet metal according to the size of the bottom plate portion 20A. The locking portion 22 of the chassis side wall portion 20B illustrated in FIG. 2 is formed by partially tapping the chassis side wall portion 20B outward. In this manner, the tray-shaped chassis 20 opened toward the front side is prepared.

In the chassis preparation step (S1), as illustrated in FIG. 5B, the optical component 190 is further disposed inside the chassis 20 that is a region surrounded by the bottom plate portion 20A and the chassis side wall portion 20B. The optical component 190 is disposed inside the chassis 20 by stacking the reflection sheet 19, the light guide plate 17, and the optical sheets 18 on the bottom plate portion 20A in this order. In addition, as illustrated in FIG. 2, the LED substrate 16 is attached to the inside of the chassis 20, whereby the LEDs 15 are disposed inside the chassis 20.

Next, in the frame preparation step (S2), the frame 21 is prepared as illustrated in FIG. 5C. As described above, the frame 21 includes the main body frame portion 21A and the frame side wall portion 21B. The frame 21 is formed by injection-molding synthetic resin or the like. In a case where the frame 21 is made of metal, the frame 21 may be formed by processing a sheet metal. The frame side wall portion 21B has opening 23 penetrating the frame side wall portion 21B along the plate thickness direction as illustrated in FIG. 2.

Next, the lighting device assembling step (S3), as illustrated in FIG. 6A, includes covering the chassis 20 that is prepared in the chassis preparation step (S1) and inside which the optical component 190 and the like are disposed with the frame 21 prepared in the frame preparation step (S2) from the front side. Specifically, the frame 21 covers the chassis 20 so that the frame side wall portion 21B is disposed outside the chassis side wall portion 20B of the chassis 20 in a state where the main body frame portion 21A of the frame 21 overlaps the outer peripheral end portion of the optical component 190. At this time, as illustrated in FIG. 2, the locking portion 22 of the chassis side wall portion 20B is locked inside the opening 23 of the frame side wall portion 21B. As a result, the frame 21 is assembled to the chassis 20, and the optical component 190 and the LEDs 15 are sandwiched and held between the chassis 20 and the frame 21. In this state, the gap 24 due to assembly tolerance of the frame 21 and the chassis 20 is formed between the frame side wall portion 21B and the chassis side wall portion 20B.

Next, in the hot melt resin disposing step (S4), a hot melt resin is disposed in the gap 24. First, as illustrated in FIG. 6B, a structure in which the optical component 190 and the LEDs 15 are held so as to be sandwiched between the chassis 20 and the frame 21 assembled in the lighting device assembling step (S3) is disposed on a workbench or the like so that the opening end of the gap 24 faces upward. In FIG. 6B, the upper side of the drawing is defined as an upward direction, and the lower side is defined as a downward direction. When heated by a dispenser D called a hot gun having a heater therein, the hot melt resin melts and is liquefied. The liquefied hot melt resin is ejected from the dispenser D and poured into the gap 24 from the opening end facing upward. Examples of the moisture-curable hot melt resin used in the present embodiment include RD-15605 manufactured by Sunstar Engineering Inc. as a silicone-based resin, and RD-15492 manufactured by Sunstar Engineering Inc. as a urethane-based resin. As the hot melt resin, other types such as UV curable resins may be used.

In the hot melt resin disposing step (S4), when the liquid hot melt resin is poured into the gap 24, the opening end of the gap 24 does not necessarily have to face upward, for example, the opening end of the gap 24 may face left or right. On the other hand, by performing the hot melt resin disposing step (S4) so that the opening end of the gap 24 faces upward, the hot melt resin easily flows uniformly into the whole of the gap 24. When the hot melt resin disposing step (S4) is performed with the opening end of the gap 24 facing upward, the liquefied hot melt resin easily flows into a position between the front side end portion of the chassis side wall portion 20B and the back side of the main body frame portion 21A of the frame 21. In the first embodiment, in order to dispose the hot melt resin into the entire gap 24 and to dispose the hot melt resin at a position between the front side end portion of the chassis side wall portion 20B and the back side of the main body frame portion 21A of the frame 21, it is preferable to perform the hot melt resin disposing step (S4) so that the opening end of the gap 24 faces upward.

Thereafter, as illustrated in FIG. 6C, the hot melt resin is cured to form the fixing portion 25 entirely in the gap 24 and at a position between the front side end portion of the chassis side wall portion 20B and the back side of the main body frame portion 21A of the frame 21. Thus, the backlight device 12 is completed. As described above, in the method of manufacturing the backlight device 12, the chassis 20 and the frame 21 can be fixed to each other by the fixing portion 25 with which the gap 24 between the chassis side wall portion 20B and the frame side wall portion 21B is filled. Therefore, even when there is a variation in the size of the gap 24 between the chassis 20 and the frame 21 due to assembly tolerance, it is possible to easily suppress the occurrence of abnormal noise and generation of foreign matter at the time of vibration at low cost. In addition, by pouring the hot melt resin into the gap 24 without providing a dedicated component for filling the gap 24, the fixing portion 25 can be easily and reliably formed without requiring any special skill, so that the manufacturing cost of the backlight device 12 can be further reduced.

Note that the fixing portion 25 formed by curing the hot melt resin is softened again by being heated. Therefore, for example, by heating and softening fixing portion 25 using hot air of a hair dryer or the like, the softened fixing portion 25 can be removed from the chassis 20 and the frame 21. That is, when a defect such as a failure occurs in the backlight device 12, the fixing portion 25 can be easily removed, the frame 21 can be removed from the chassis 20, and the backlight device 12 can be disassembled and repaired. As described above, in the backlight device 12, the fixing portion 25 is formed of the hot melt resin, so that the ease of repair of the backlight device 12 can also be secured.

As described above, the backlight device 12 includes the chassis 20 that is opened toward the front side and inside which the sheet-like optical component 190 is disposed, and the frame 21 that covers the chassis 20 from the front side. The chassis 20 includes the bottom plate portion 20A and the chassis side wall portion 20B rising from an outer peripheral end portion of the bottom plate portion 20A toward the front side. The frame 21 includes the main body frame portion 21A and the frame side wall portion 21B rising from an outer peripheral end portion of the main body frame portion 21A toward the back side, and covers the chassis 20 from the front side, the frame side wall portion 21B being disposed outside the chassis side wall portion 20B in a state where the main body frame portion 21A overlaps at least part of the optical component 190. The backlight device 12 further includes the fixing portion 25 that is formed in part or the whole of the gap 24 formed at least between the chassis side wall portion 20B and the frame side wall portion 21B and fixes the chassis 20 and the frame 21, and the fixing portion 25 is formed of a hot melt resin.

The method of manufacturing backlight device 12 includes: the chassis preparation step (S1) of disposing the sheet-like optical component 190 inside the chassis 20 that is opened toward the front side, the chassis including the bottom plate portion 20A and the chassis side wall portion 20B rising from the outer peripheral end portion of the bottom plate portion 20A toward the front side; the frame preparation step (S2) of preparing the frame 21 including the main body frame portion 21A and the frame side wall portion 21B falling from the outer peripheral end portion of the main body frame portion 21A toward the back side; the lighting device assembling step (S3) of covering the chassis 20 with the frame 21 from the front side so that the frame side wall portion 21B is disposed outside the chassis side wall portion 20B in a state where the main body frame portion 21A overlaps at least part of the optical component 190; and the hot melt resin disposing step (S4) of disposing a hot melt resin in part or the whole of the gap 24 formed at least between the chassis side wall portion 20B and the frame side wall portion 21B.

The size of the gap 24 formed between the chassis side wall portion 20B and the frame side wall portion 21B may vary due to assembly tolerance. The hot melt resin has fluidity at the time of use (at the time of manufacturing a lighting device). Therefore, the gap 24 can appropriately filled with the fixing portion 25 according to the size of the gap 24 formed between the chassis side wall portion 20B and the frame side wall portion 21B. In this manner, since the fixing portion 25 can fix the chassis 20 and the frame 21, it is not necessary to provide a dedicated component for filling the gap 24 between the chassis side wall portion 20B and the frame side wall portion 21B. Therefore, according to the backlight device 12 and the method of manufacturing the same according to the first embodiment, even when the size of the gap 24 varies due to assembly tolerance, the occurrence of abnormal noise and generation of foreign matter at the time of vibration of the backlight device 12 can be easily suppressed at low cost.

### Details of Second Embodiment of Present Disclosure

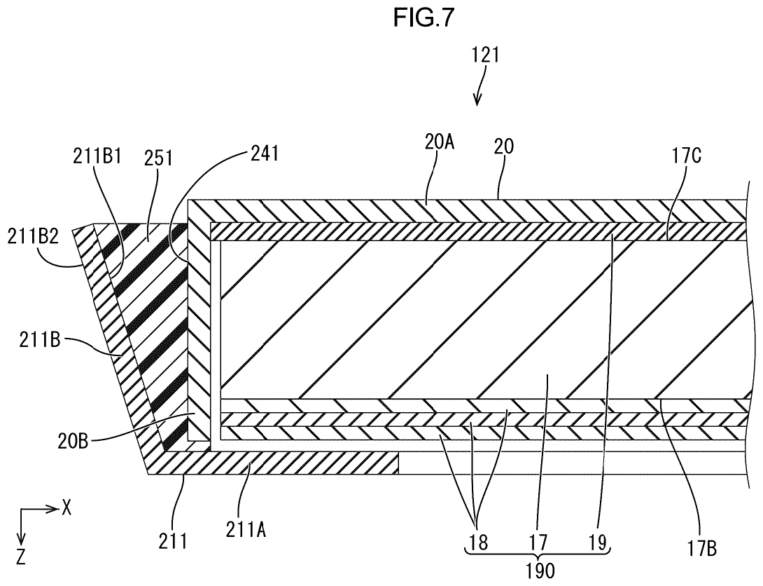

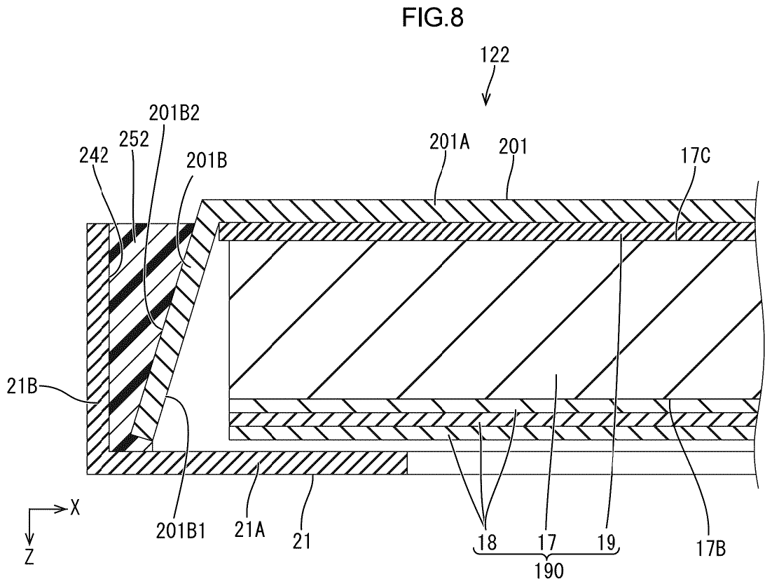

A second embodiment of the present disclosure will be described with reference to FIGS. 7 and 8. In the second embodiment, the same reference numerals are used for the same parts as those in the first embodiment, and redundant description of the structure, operation, and effect will be omitted.

As illustrated in FIG. 7, a backlight device 121 according to the second embodiment includes a chassis 20 and a frame 211. The frame 211 includes a main body frame portion 211A and a frame side wall portion 211B that falls from an outer peripheral end portion of the main body frame portion 211A toward the back side and has a short tubular shape. An optical component 190 accommodated inside the chassis 20 is held by being sandwiched by the chassis 20 and the frame 211 from the back side and the front side in the Z axis direction. Between an outer face of a chassis side wall portion 20B and an inner face 211B1 of the frame side wall portion 211B, a gap 241 for absorbing assembly tolerance between the frame 211 and the chassis 20 is provided.

The main body frame portion 211A of the frame 211 is formed in the same manner as the main body frame portion 21A of the frame 21 of the first embodiment. On the other hand, the inner face 211B1 of the frame side wall portion 211B is formed so as to be inclined with respect to the main body frame portion 211A in the frame preparation step (S2). Specifically, the inner face 211B1 of the frame side wall portion 211B is formed in an inclined shape so as to widen the space inside the frame 211 from the front side toward the back side. Therefore, the gap 241 is formed to be widened from the front side toward the back side. That is, the gap 241 is formed so as to be wider toward the opening end.

In this case, by disposing the hot melt resin in the gap 241 in the hot melt resin disposing step (S4), a fixing portion 251 that fixes the chassis 20 and the frame 211 is formed. Since the opening end of the gap 241 is likely to be formed to be wider than the opening end of the gap 24 of the first embodiment, pouring the hot melt resin into the gap 241 can be performed more easily than pouring the hot melt resin into the gap 24. Therefore, since the hot melt resin can be reliably disposed in the gap 241, the fixing portion 251 can more reliably fix the chassis 20 and the frame 211. In addition, with such a configuration, the work efficiency of the hot melt disposing step (S4) is improved, so that the cost of the backlight device 121 can be reduced.

FIG. 7 illustrates an example of the frame side wall portion 211B formed by the inner face 211B1 and an outer face 211B2 extending in parallel. At least the inner face 211B1 of the frame side wall portion 211B only needs to be formed at an angle that widens the gap 241 from the front side to the back side. Therefore, for example, the outer face 211B2 of the frame side wall portion 211B may be formed not to be parallel to the inner face 211B1 but to extend in a direction orthogonal to the main body frame portion 211A.

As a modification of the backlight device 121 according to the second embodiment, a backlight device 122 includes a chassis 201 and a frame 21 as illustrated in FIG. 8. The chassis 201 includes a bottom plate portion 201A and a chassis side wall portion 201B rising from an outer peripheral end portion of the bottom plate portion 201A toward the front side. An optical component 190 accommodated inside the chassis 201 is held by being sandwiched from the back side and the front side in the Z axis direction by the chassis 201 and the frame 21. A gap 242 for absorbing assembly tolerance between the frame 21 and the chassis 201 is provided between an outer face 201B2 of the chassis side wall portion 201B and an inner face of a frame side wall portion 21B.

The bottom plate portion 201A of the chassis 201 is formed in the same manner as the bottom plate portion 20A of the chassis 20 of the first embodiment. On the other hand, the outer face 201B2 of the chassis side wall portion 201B is formed so as to be inclined with respect to the bottom plate portion 201A in the chassis preparation step (S1). Specifically, the outer face 201B2 of the chassis side wall portion 201B is formed in an inclined shape so as to widen the space inside the chassis 201 from the front side toward the back side. Therefore, the gap 242 is formed to be widened from the front side toward the back side. That is, the gap 242 is formed so as to be wider toward the opening end.

In this case, by disposing the hot melt resin in the gap 242 in the hot melt resin disposing step (S4), a fixing portion 252 that fixes the chassis 201 and the frame 21 is formed. Since the opening end of the gap 242 is likely to be formed to be wider than the opening end of the gap 24 of the first embodiment, pouring the hot melt resin into the gap 242 can be performed more easily than pouring the hot melt resin into the gap 24. Therefore, since the hot melt resin can be reliably disposed in the gap 242, the fixing portion 252 can more reliably fix the chassis 201 and the frame 21. In addition, with such a configuration, the work efficiency of the hot melt disposing step (S4) is improved, so that the cost of the backlight device 122 can be reduced.

Note that FIG. 8 illustrates an example of the chassis side wall portion 201B formed by the outer face 201B2 and an inner face 201B1 extending in parallel. At least the outer face 201B2 of the chassis side wall portion 201B only needs to be formed at an angle that widens the gap 242 from the front side to the back side. Therefore, for example, the inner face 201B1 of the chassis side wall portion 201B may be formed not to be parallel to the outer face 201B2 but to extend in a direction orthogonal to the bottom plate portion 201A.

As described above, in the backlight device 121, the gap 241 between the chassis side wall portion 20B and the frame side wall portion 211B is formed to be widened from the front side toward the back side. Further, in the backlight device 122, the gap 242 between the chassis side wall portion 201B and the frame side wall portion 21B is formed to be widened from the front side toward the back side.

In the method of manufacturing the backlight device 121, in the frame preparation step (S2), the inner face 211B1 of the frame side wall portion 211B is formed so as to be inclined with respect to the main body frame portion 211A. Then, when the frame 211 covers the chassis 20 from the front side in the lighting device assembling step (S3), the gap 241 between the outer face of the chassis side wall portion 20B and the inner face 211B1 of the frame side wall portion 211B is formed so as to be widened from the front side toward the back side. In the method of manufacturing the backlight device 122, in the chassis preparation step (S1), the outer face 201B2 of the chassis side wall portion 201B is formed so as to be inclined with respect to the bottom plate portion 20A. Then, when the frame 21 covers the chassis 201 from the front side in the lighting device assembling step (S3), the gap 242 between the outer face 201B2 of the chassis side wall portion 201B and the inner face of the frame side wall portion 21B is formed so as to be widened from the front side toward the back side.

In this case, the hot melt resin is easily injected into the gaps 241, 242 from the back side. Therefore, since the chassis 20 and the frame 211 of the backlight device 121 and the chassis 201 and the frame 21 of the backlight device 122 are more appropriately fixed, the occurrence of abnormal noise is further suppressed.

In the second embodiment, a new backlight device may be formed using both the frame 211 of the backlight device 121 and the chassis 201 of the backlight device 122. Also in this case, since the opening end of the gap between the chassis side wall portion and the frame side wall portion can be formed to be wider than that in the first embodiment, it is easy to reliably provide the fixing portion between the chassis side wall portion and the frame side wall portion. As a result, since the chassis and the frame of the backlight device are each more appropriately fixed, the occurrence of abnormal noise is further suppressed.

### Details of Third Embodiment of Present Disclosure

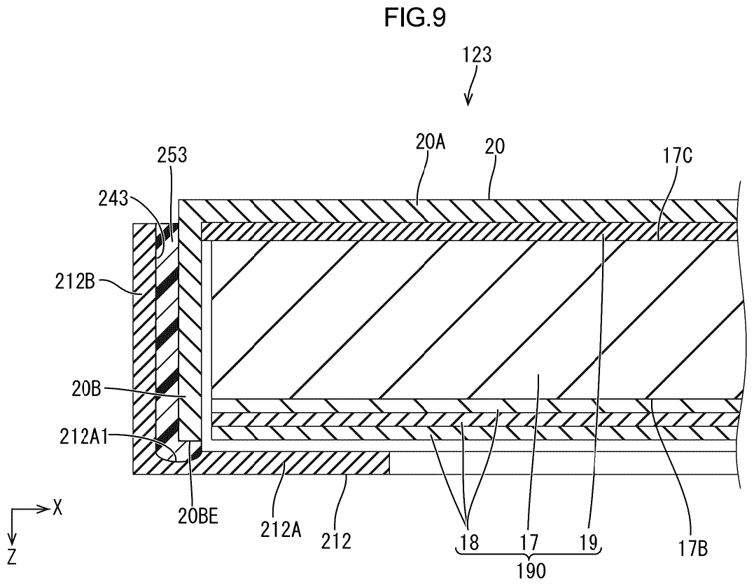

A third embodiment of the present disclosure will be described with reference to FIG. 9. In the third embodiment, the same reference numerals are used for the same parts as those in the first embodiment, and redundant description of the structure, operation, and effect will be omitted.

As illustrated in FIG. 9, a backlight device 123 according to the third embodiment includes a chassis 20 and a frame 212. The frame 212 includes a main body frame portion 212A and a frame side wall portion 212B that falls from an outer peripheral end portion of the main body frame portion 212A toward the back side and has a short tubular shape, and the main body frame portion 212A has a first recess 212A1 that is recessed toward the front side. An optical component 190 accommodated inside the chassis 20 is held by being sandwiched by the chassis 20 and the frame 212 from the back side and the front side in the Z axis direction. Between a chassis side wall portion 20B and an inner face of the frame side wall portion 212B, a gap 243 for absorbing assembly tolerance between the frame 212 and the chassis 20 is provided. The frame side wall portion 212B is formed in the same manner as the frame side wall portion 21B of the frame 21 of the first embodiment.

In the frame preparation step (S2), the main body frame portion 212A has a first recess 212A1 recessed toward the front side. The first recess 212A1 is formed by recessing the back face of the main body frame portion 212A toward the front side in a portion of the back face of the main body frame portion 212A, the portion being close to a front side end portion 20BE of the chassis side wall portion 20B in a case where the frame 212 covers the chassis 20 from the front side in the lighting device assembling step (S3). By providing the first recess 212A1, assembly tolerance between the frame 212 and the chassis 20 is absorbed, and contact between the front side end portion 20BE of the chassis side wall portion 20B of the chassis 20 covered by the frame 212 and the main body frame portion 212A of the frame 212 is suppressed. Therefore, the occurrence of abnormal noise is further suppressed.

In addition, in a case where the first recess 212A1 is provided, the gap 243 between the chassis side wall portion 20B and the inner face of the frame side wall portion 212B is formed continuously with the space between the front side end portion of the chassis side wall portion 20B and the first recess 212A1. Therefore, when the hot melt resin is poured into the gap 243 in the hot melt disposing step (S4), the hot melt resin flows into and accumulates in the first recess 212A1. By curing the hot melt resin poured into the gap 243, a fixing portion 253 is formed not only between the chassis side wall portion 20B and the inner face of the frame side wall portion 212B but also in the portion of the first recess 212A1. As a result, the front side end portion 20BE of the chassis side wall portion 20B is fixed to the back face of the main body frame portion 212A by the fixing portion 253. Therefore, since the chassis 20 and the frame 212 of the backlight device 123 are more appropriately fixed, the occurrence of abnormal noise is further suppressed.

As described above, in the backlight device 123, the first recess 212A1 that is recessed toward the front side is formed in a portion of the main body frame portion 212A, the portion being close to the front side end portion 20BE of the chassis side wall portion 20B.

In the method of manufacturing the backlight device 123, in the frame preparation step (S2), the first recess 212A1 that is recessed toward the front side is formed in a portion of the main body frame portion 212A, the portion being close to the front side end portion 20BE of the chassis side wall portion 20B.

By forming the first recess 212A1 in the main body frame portion 212A, contact between the front side end portion 20BE of the chassis side wall portion 20B of chassis 20 covered by the frame 212 and the main body frame portion 212A of frame 212 is suppressed. In addition, the hot melt resin with which the gap 243 between the chassis side wall portion 20B and the frame side wall portion 212B is filled easily flows into and accumulates in the first recess 212A1. Therefore, the hot melt resin is disposed in the first recess 212A1 between the front side end portion of the chassis side wall portion 20B and the main body frame portion 212A of the frame 212 to form the fixing portion 253. Therefore, since the chassis 20 and the frame 212 are more appropriately fixed by the fixing portion 253, the occurrence of abnormal noise is further suppressed.

### Details of Fourth Embodiment of Present Disclosure

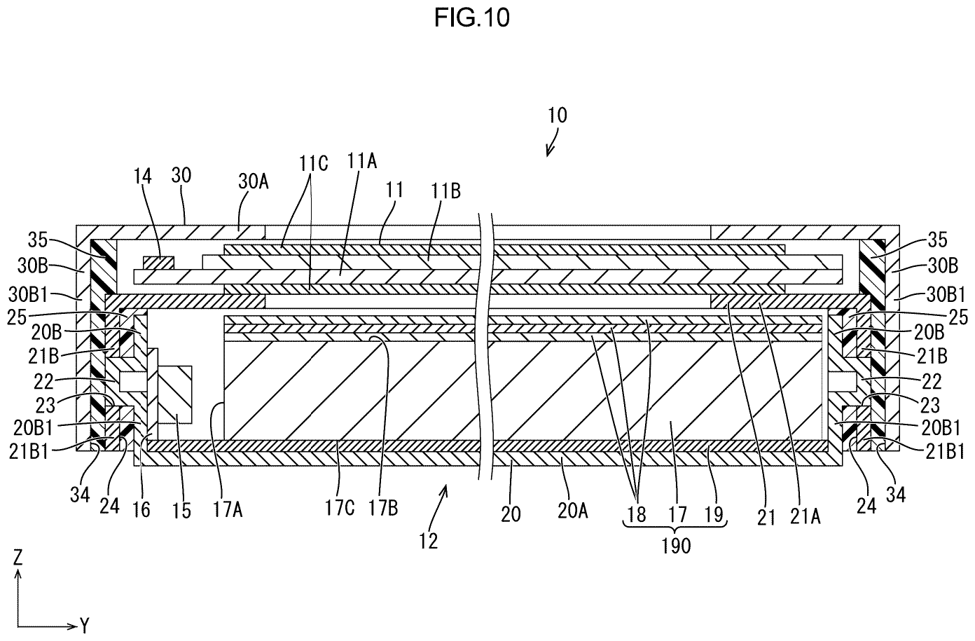

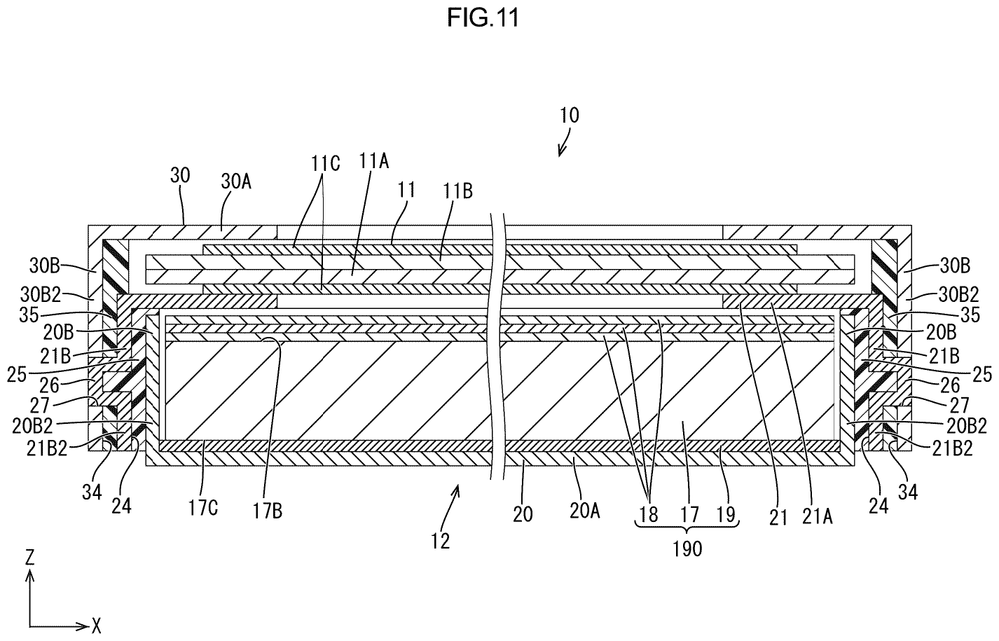

A schematic configuration of a liquid crystal display device 10 according to a fourth embodiment of the present disclosure will be described with reference to FIGS. 10 and 11. As illustrated in FIGS. 10 and 11, the liquid crystal display device 10 includes the backlight device 12 and the liquid crystal panel 11 of the first embodiment, which are integrally held by the frame-shaped bezel 30.

As illustrated in FIGS. 10 and 11, the liquid crystal panel 11 has a configuration in which a pair of substantially transparent glass substrates 11A and 11B are bonded to each other with a predetermined gap therebetween, and liquid crystal is sealed between the substrates 11A and 11B. Of the pair of substrates 11A and 11B, an array substrate 11A disposed on the back side is provided with switching elements (for example, TFTs) connected to source lines and gate lines orthogonal to each other, pixel electrodes connected to the switching elements, an alignment film, and the like. In addition, a CF substrate 11B disposed on the front side is provided with a color filter in which colored portions such as red (R), green (G), and blue (B) are disposed in a predetermined array, a counter electrode, an alignment film, and the like. Among them, a driver 14 for driving the liquid crystal panel 11 and a flexible substrate (not illustrated) are mounted on the array substrate 11A. Note that a pair of front and back polarizing plates 11C is attached to the outer face sides of the pair of substrates 11A and 11B, respectively.

As illustrated in FIG. 10, the bezel 30 includes an edge portion 30A and a bezel side wall portion 30B. The bezel 30 is made of metal as in the chassis 20, and covers the liquid crystal panel 11 from the front side. The bezel may be made of synthetic resin or the like. The edge portion 30A has a horizontally long frame shape as a whole, and has a frame shape with a constant width in which the inner dimension of each side is substantially the same as or larger than the length of each side of the display region of the liquid crystal panel 11, and the outer dimension of each side is larger than the outer dimension of each side of the liquid crystal panel 11. The edge portion 30A is disposed so as to overlap an outer peripheral end portion (non-display region) of the liquid crystal panel 11 from the front side, and covers the display region of the liquid crystal panel 11 from the front side over the entire circumference.

The bezel side wall portion 30B is a portion that falls from the outer peripheral end portion of the edge portion 30A toward the back side (the side opposite to the light emission side) to form a short tubular shape. The bezel side wall portion 30B has a horizontally long rectangular frame shape in plan view, and includes a pair of long side portions 30B1 and a pair of short side portions 30B2 orthogonal to each other. The bezel side wall portion 30B surrounds the frame side wall portion 21B so as to overlap the outer side of the frame side wall portion 21B, and is disposed so that the inner face of the bezel side wall portion 30B faces the outer face of the frame side wall portion 21B over the entire circumference. Between the inner face of the bezel side wall portion 30B and the outer face of the frame side wall portion 21B, a gap 34 for absorbing assembly tolerance between the bezel 30 and the frame 21 is provided. This ensures ease of assembly of the bezel 30 to the frame 21.

As illustrated in FIG. 11, the bezel side wall portion 30B of the bezel 30 has an opening 27 as in the frame side wall portion 21B (see FIGS. 1 and 2) of the frame 21 according to the first embodiment. The opening 27 is a through hole that penetrates the bezel side wall portion 30B along the plate thickness direction, and as illustrated in FIG. 11, the locking portion 26 (see also FIG. 1) of the frame 21 enters the opening 27 and is locked to the back side of the opening edge. Accordingly, the bezel 30 is held by the frame 21. A certain dimensional difference is secured between the inner dimension of the opening 27 and the outer dimension of the locking portion 26. As a result, the fixing function of the opening 27 and the locking portion 26 is reliably exhibited regardless of the presence or absence of a manufacturing error or the like.

Although not illustrated, the circumferential arrangement of the opening 27 in the bezel side wall portion 30B matches the circumferential arrangement of the locking portion 26 in the frame side wall portion 21B. Specifically, one opening is disposed near the central position in the length direction of each of the pair of short side portions 30B2 (see FIG. 11) constituting the bezel side wall portion 30B, and two openings are disposed at two positions sandwiching the central position in the length direction of each of the pair of long side portions 30B1 (see FIG. 10).

As illustrated in FIGS. 10 and 11, a fixing portion 35 is formed in the gap 34 formed between the bezel side wall portion 30B and the frame side wall portion 21B. The fixing portion 35 is provided by disposing a hot melt resin in the gap 34, and fixes the bezel 30 and the frame 21. As the hot melt resin, the resin same as that in the first embodiment is used.

As illustrated in FIGS. 10 and 11, the fixing portion 35 is provided so as to surround the entire outer face of the frame side wall portion 21B over the entire circumference of the gap 34, that is, between the bezel side wall portion 30B and the frame side wall portion 21B. As a result, even when vibration acts on the liquid crystal display device 10 when rattling due to assembly tolerance or rattling due to a dimensional difference between the locking portion 26 and the opening 27 occurs between the bezel side wall portion 30B and the frame 21, a situation in which the bezel side wall portion 30B and the frame side wall portion 21B come into contact with each other (interfere with each other) hardly occurs. Therefore, the occurrence of abnormal noise (noise) due to the contact between the bezel side wall portion 30B and the frame side wall portion 21B is suppressed. Further, generation of foreign matter that is dust generated by scraping part of the bezel side wall portion 30B or part of the frame side wall portion 21B due to contact between the bezel side wall portion 30B and the frame side wall portion 21B inside the liquid crystal display device 10 is suppressed.

In the fourth embodiment, the fixing portion 35 is also provided at a position between the outer peripheral end portion of the front side of the main body frame portion 21A of the frame 21 and the outer peripheral end portion of the back side of the edge portion 30A of the bezel 30. Thus, the bezel 30 and the frame 21 are more reliably fixed, and a situation in which the bezel side wall portion 30B and the frame side wall portion 21B come into contact with each other hardly occurs. Therefore, the occurrence of abnormal noise and generation of foreign matter in the liquid crystal display device 10 is further suppressed. Specifically, since the liquid crystal display device 10 according to the present embodiment is mounted on a vehicle, vibration such as road noise may frequently act on the liquid crystal display device 10. In this respect, since the fixing portion 35 can suitably suppress the contact between the bezel 30 and the frame 21, noise in the vehicle interior space can be reduced.

The fixing portion 35 can be provided by disposing a hot melt resin in the gap 34 between the existing bezel side wall portion 30B and the existing frame side wall portion 21B. That is, it is possible to suppress the contact between the bezel side wall portion 30B and the frame side wall portion 21B without newly designing a dedicated component for filling the gap 34 or without changing the shape or the like of the existing bezel side wall portion 30B and the existing frame side wall portion 21B in order to install the dedicated component in the gap 34. In a case where a dedicated component is provided, even in a case where the existing bezel side wall portion 30B and the existing frame side wall portion 21B are used, a step of sandwiching the dedicated component between the bezel side wall portion 30B and the frame side wall portion 21B is required, and this step is assumed to take time and effort. In this respect, in the case of using the fixing portion 35, the number of components and the assembling step are reduced, as compared with those in the case of installing a dedicated component as in the related art, so that the cost can be reduced.

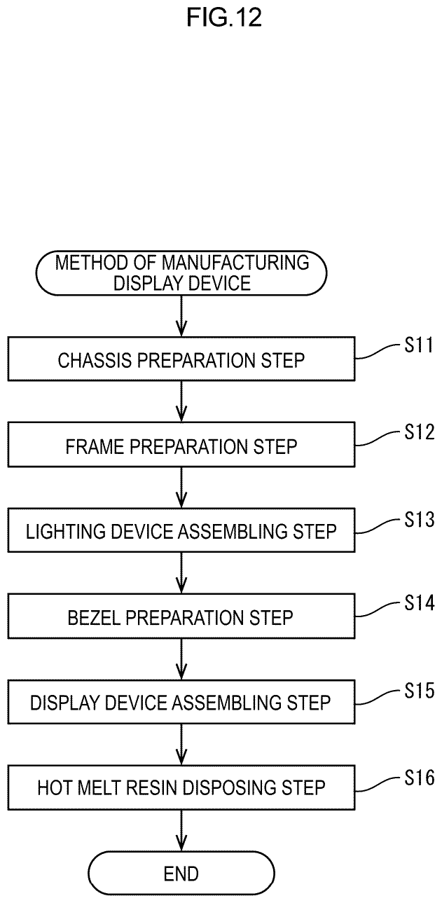

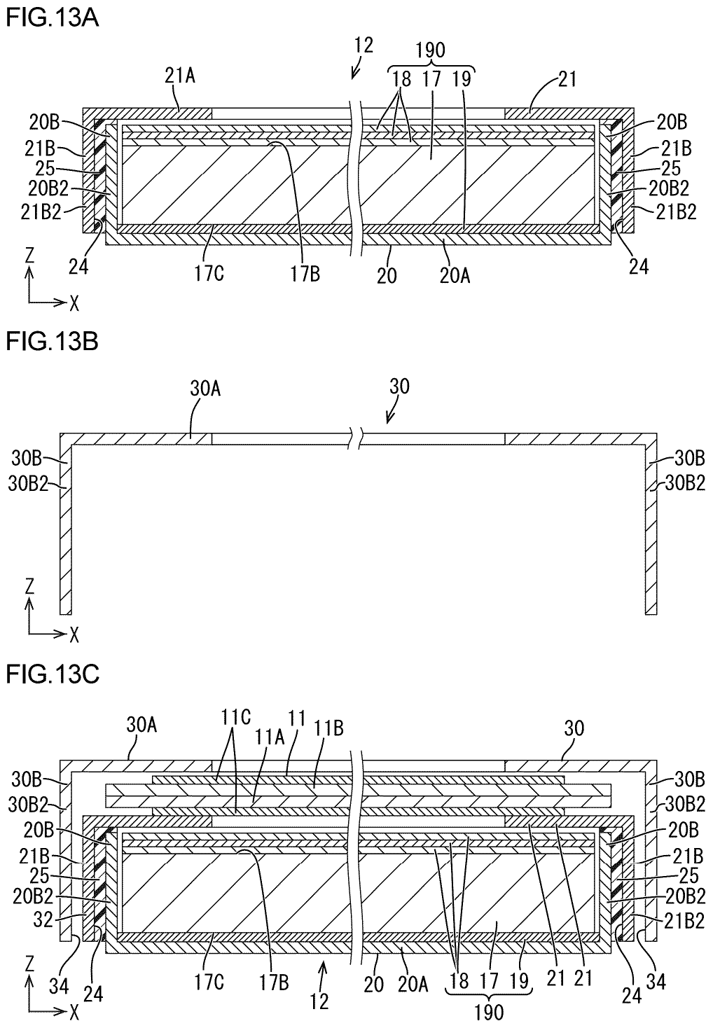

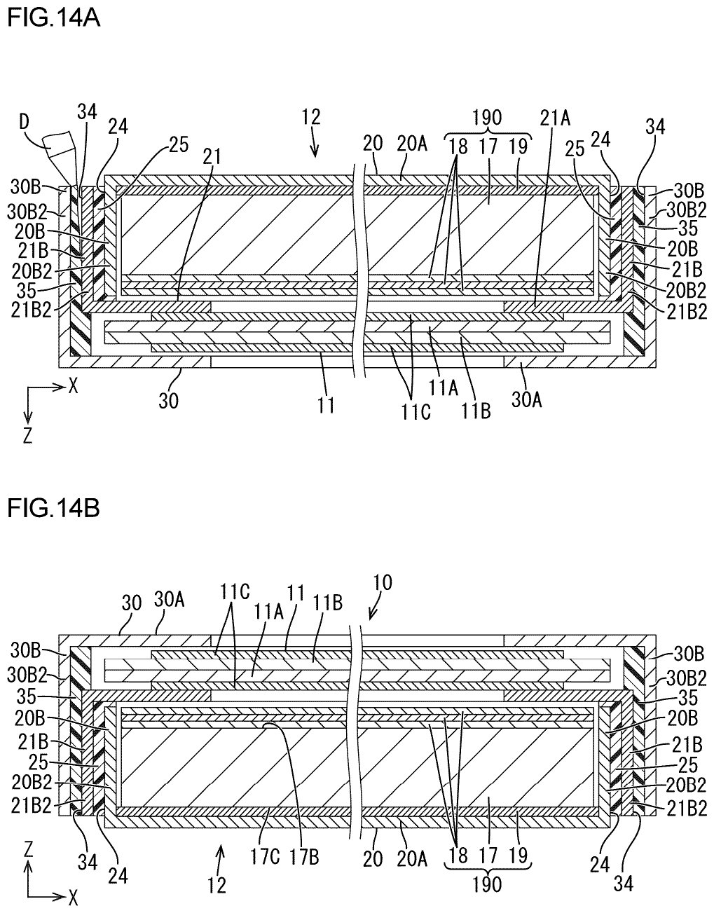

Next, a method of manufacturing the liquid crystal display device 10 will be described with reference to FIGS. 12 to 14. In the following description, each step of the method of manufacturing the liquid crystal display device 10 is abbreviated as “S”. As illustrated in FIG. 12, the method of manufacturing the liquid crystal display device 10 includes at least a chassis preparation step (S11), a frame preparation step (S12), a lighting device assembling step (S13), a bezel preparation step (S14), a display device assembling step (S15), and a hot melt resin disposing step (S16). Of these steps, the chassis preparation step (S11), the frame preparation step (S12), and the lighting device assembling step (S13) are similar to the chassis preparation step (S1), the frame preparation step (S2), and the lighting device assembling step (S3) of the first embodiment, and thus detailed description thereof is omitted. Each step will be sequentially described with reference to FIG. 13A to FIG. 13C, FIGS. 14A and 14B.

By executing the chassis preparation step (S11), the frame preparation step (S12), and the lighting device assembling step (S13), the backlight device 12 is prepared as illustrated in FIG. 13A. In the fourth embodiment, in the backlight device used for manufacturing the liquid crystal display device 10, the fixing portion 25 made of the hot melt resin need not be provided in the gap 24 between the frame side wall portion 21B and the chassis side wall portion 20B.

Next, in the bezel preparation step (S14), the bezel 30 is prepared as illustrated in FIG. 13B. As described above, the bezel 30 includes the edge portion 30A and the bezel side wall portion 30B. The bezel 30 is formed by processing a sheet metal. The bezel 30 may be formed by injection-molding synthetic resin or the like. The bezel side wall portion 30B has the opening 27 that penetrates the bezel side wall portion 30B along the plate thickness direction as illustrated in FIG. 11.

Next, in the display device assembling step (S15), as illustrated in FIG. 13C, first, the front side of the backlight device 12 is disposed on the back side of the liquid crystal panel 11. The bezel 30 is made to cover the front side of the liquid crystal panel 11 so that the bezel side wall portion 30B is disposed outside the frame side wall portion 21B in a state where the edge portion 30A of the bezel 30 prepared in the bezel preparation step (S14) overlaps the portion surrounding the display region of the liquid crystal panel 11. In this way, the backlight device 12 and the liquid crystal panel 11 are integrally held by the bezel 30. In this state, the gap 34 due to assembly tolerance of the bezel 30 and the frame 21 is formed between the bezel side wall portion 30B and the frame side wall portion 21B.

Next, in the hot melt resin disposing step (S16), a hot melt resin is disposed in the gap 34. First, as illustrated in FIG. 14A, a structure in which the backlight device 12 and the liquid crystal panel 11 assembled in the display device assembling step (S15) are integrally held by the bezel 30 is disposed on a workbench or the like so that the opening end of the gap 34 faces upward. In FIG. 14A, the upper side of the drawing is defined as the upward direction, and the lower side is defined as the downward direction. Then, the hot melt resin is ejected from the dispenser D and poured into the gap 34 from the opening end facing upward.

In the hot melt resin disposing step (S16), as in the hot melt resin disposing step (S4) of the first embodiment, when the liquid hot melt resin is poured into the gap 34, the opening end of the gap 34 does not necessarily have to face upward, for example, the opening end of the gap 34 may face left or right. On the other hand, by performing the hot melt resin disposing step (S16) so that the opening end of the gap 34 faces upward, the hot melt resin easily flows uniformly into the entire gap 34. When the hot melt resin disposing step (S16) is performed with the opening end of the gap 34 facing upward, the liquefied hot melt resin is likely to flow into a position between the outer peripheral end portion of the front side of the main body frame portion 21A of the frame 21 and the outer peripheral end portion of the back side of the edge portion 30A of the bezel 30. In the fourth embodiment, in order to dispose the hot melt resin in the entire gap 34 and to dispose the hot melt resin at a position between the outer peripheral end portion of the front side of the main body frame portion 21A of the frame 21 and the outer peripheral end portion of the back side of the edge portion 30A of the bezel 30, the hot melt resin disposing step (S16) is preferably performed so that the opening end of the gap 34 faces upward.

Thereafter, as illustrated in FIG. 14B, the hot melt resin is cured to form the fixing portion 35 in the entire gap 34 and at a position between the outer peripheral end portion of the front side of the main body frame portion 21A of the frame 21 and the outer peripheral end portion of the back side of the edge portion 30A of the bezel 30. Thus, the liquid crystal display device 10 is completed. As described above, in the method of manufacturing the liquid crystal display device 10, the bezel 30 and the frame 21 can be fixed to each other by the fixing portion 35 with which the gap 34 between the bezel side wall portion 30B and the frame side wall portion 21B is filled. Therefore, even when the size of the gap 34 between the bezel 30 and the frame 21 varies due to assembly tolerance, occurrence of abnormal noise and generation of foreign matter at the time of vibration can be easily suppressed at low cost. In addition, by pouring the hot melt resin into the gap 34 without providing a dedicated component for filling the gap 34, the fixing portion 35 can be easily and reliably formed without requiring special skill, and thus the manufacturing cost of the liquid crystal display device 10 can be further reduced.

Note that the fixing portion 35 formed by curing the hot melt resin is softened again by being heated. For this reason, the softened fixing portion 35 can be removed from the bezel 30 and the frame 21 by heating and softening the fixing portion 35 using, for example, hot air of a hair dryer. That is, when a defect such as a failure occurs in the liquid crystal display device 10, the fixing portion 35 can be easily removed, the bezel 30 can be removed from the backlight device 12, and the liquid crystal display device 10 can be disassembled and repaired. As described above, in the liquid crystal display device 10, ease of repair of the liquid crystal display device 10 can also be secured by forming the fixing portion 35 with the hot melt resin.

As described above, the liquid crystal display device 10 includes the liquid crystal panel 11, the bezel 30 covering the liquid crystal panel 11 from the front side, and the backlight device 12 disposed on the back side of the liquid crystal panel 11. The bezel 30 includes the edge portion 30A surrounding the display region of the liquid crystal panel 11 on the front side of the liquid crystal panel 11, and the bezel side wall portion 30B falling from the outer peripheral end portion of the edge portion 30A toward the back side. The backlight device 12 includes the chassis 20 that is opened toward the front side and inside which the sheet-like optical component 190 is disposed, and the frame 21 that covers the chassis 20 from the front side. The frame 21 includes the main body frame portion 21A and the frame side wall portion 21B rising from an outer peripheral end portion of the main body frame portion 21A toward the back side, and covers the chassis 20 from the front side, the frame side wall portion 21B being disposed outside the chassis side wall portion 20B in a state where the main body frame portion 21A overlaps at least part of the optical component 190. The bezel side wall portion 30B is disposed outside the frame side wall portion 21B, is formed at least in part or the whole of the gap 34 formed between the bezel side wall portion 30B and the frame side wall portion 21B, and further includes the fixing portion 35 that fixes the bezel 30 and the frame 21, and the fixing portion 35 is formed of a hot melt resin.

The method of manufacturing the liquid crystal display device 10 includes: the chassis preparation step (S11) of preparing the chassis 20 that is opened toward the front side and inside which the sheet-like optical component 190 is disposed; the frame preparation step (S12) of preparing the frame 21 including the main body frame portion 21A and the frame side wall portion 21B falling from the outer peripheral end portion of the main body frame portion 21A toward the back side; the lighting device assembling step (S13) of assembling the backlight device 12 by covering the chassis 20 with the frame 21 from the front side so that the frame side wall portion 21B is disposed outside the chassis side wall portion 20B in a state where the main body frame portion 21A overlaps at least part of the optical component 190; the bezel preparation step (S14) of preparing the bezel 30 including the edge portion 30A surrounding a display region of the liquid crystal panel 11 and the bezel side wall portion 30B falling from the outer peripheral end portion of the edge portion 30A toward the back side; the display device assembling step (S15) of disposing the front side of the backlight device 12 on the back side of the liquid crystal panel 11, and assembling the liquid crystal panel 11 to the backlight device 12 so that the bezel side wall portion 30B is disposed outside the frame side wall portion 21B in a state where the edge portion 30A of the bezel 30 overlaps a portion surrounding the display region of the liquid crystal panel 11; and the hot melt resin disposing step (S16) of disposing a hot melt resin in part or the whole of the gap 34 formed at least between the bezel side wall portion 30B and the frame side wall portion 21B.

The size of the gap 34 formed between the frame side wall portion 21B and the bezel side wall portion 30B may vary due to assembly tolerance. Since the hot melt resin has fluidity at the time of use (at the time of manufacturing the display device), the gap 34 can be appropriately filled according to the size of the gap 34 formed between the frame side wall portion 21B and the bezel side wall portion 30B. The hot melt resin with which the gap 34 is filled is cured later to fix the frame 21 and the bezel 30. Therefore, it is not necessary to provide a dedicated component for filling the gap 34 between the frame side wall portion 21B and the bezel side wall portion 30B. Therefore, the liquid crystal display device 10 and the manufacturing method thereof according to the fourth embodiment can easily suppress the occurrence of the abnormal noise at the time of vibration of the liquid crystal display device 10 at low cost even if the size of the gap 34 varies due to the assembly tolerance.

### Details of Fifth Embodiment of Present Disclosure

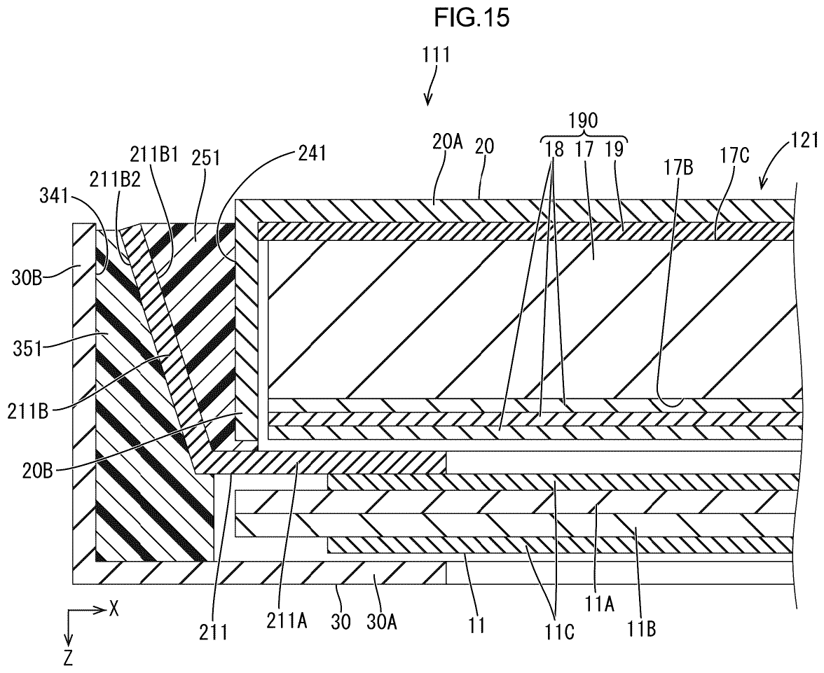

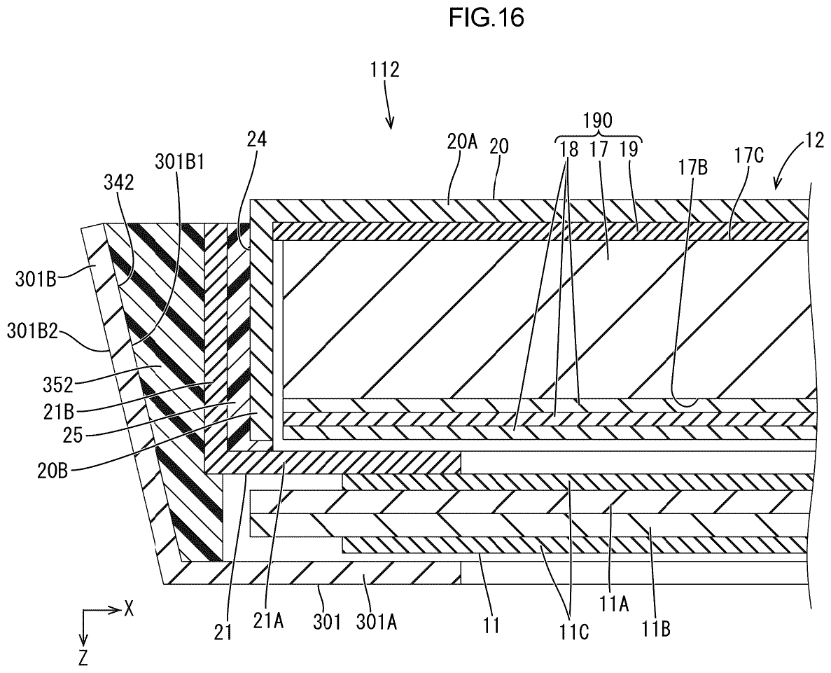

A fifth embodiment of the present disclosure will be described with reference to FIGS. 15 and 16. In the fifth embodiment, the same reference numerals are used for the same parts as those in the fourth embodiment, and redundant description of the structure, operation, and effect will be omitted.

As illustrated in FIG. 15, a liquid crystal display device 111 according to the fifth embodiment includes the backlight device 121 according to the second embodiment and the liquid crystal panel 11, which are integrally held by the frame-shaped bezel 30. As described above, the frame 211 of the backlight device 121 includes the main body frame portion 211A and the frame side wall portion 211B that falls from the outer peripheral end portion of the main body frame portion 211A toward the back side and has a short tubular shape. The inner face 211B1 and the outer face 211B2 of the frame side wall portion 211B are formed in a shape inclined with respect to the main body frame portion 211A so as to widen the space inside the frame 211 from the front side toward the back side in the frame preparation step (S12). That is, the outer face 211B2 of the frame side wall portion 211B and the inner face of the bezel side wall portion 30B face each other in an inclined manner. Between the bezel side wall portion 30B and the frame side wall portion 21B, a gap 341 for absorbing assembly tolerance between the bezel 30 and the frame 211 is provided.

In this case, by disposing the hot melt resin in the gap 341 in the hot melt resin disposing step (S16), a fixing portion 351 that fixes the frame 211 and the bezel 30 is formed. An opening end of the gap 341 is likely to be formed to be narrower than the opening end of the gap 34 of the fourth embodiment, but the inside of the gap 341 is likely to be formed to be widened from the back side toward the front side along the outer face 211B2 of the frame side wall portion 211B. Therefore, the amount of the hot melt resin disposed in the gap 341 tends to be larger than the amount of the hot melt resin disposed in the gap 34 of the fourth embodiment. Therefore, the fixing portion 351 formed of the hot melt resin disposed inside the gap 341 can more reliably fix the frame 211 and the bezel 30.

As a modification of the liquid crystal display device 111 according to the fifth embodiment, as illustrated in FIG. 16, a liquid crystal display device 112 includes the backlight device 12 and the liquid crystal panel 11 according to the first embodiment, which are integrally held by a frame-shaped bezel 301. The bezel 301 includes an edge portion 301A and a bezel side wall portion 301B rising from an outer peripheral end portion of the edge portion 301A toward the front side. Between an inner face 301B1 of the bezel side wall portion 301B and the outer face of the frame side wall portion 21B, a gap 342 for absorbing assembly tolerance between the bezel 301 and the frame 21 is provided.

The edge portion 301A of the bezel 301 is formed as in the edge portion 30A of the bezel 30 according to the fourth embodiment. On the other hand, the inner face 301B1 of the bezel side wall portion 301B is formed so as to be inclined with respect to the edge portion 301A in the bezel preparation step (S14). Specifically, the inner face 301B1 of the bezel side wall portion 301B is formed in a shape inclined so as to widen the space inside the bezel 301 from the front side to the back side. That is, the outer face of the frame side wall portion 21B and the inner face 301B1 of the bezel side wall portion 301B face each other in an inclined manner. Therefore, the gap 342 is formed to be widened from the front side toward the back side. That is, the gap 342 is formed so as to be wider toward the opening end.

In this case, by disposing the hot melt resin in the gap 342 in the hot melt resin disposing step (S16), a fixing portion 352 that fixes the frame 21 and the bezel 301 is formed. Since the opening end of the gap 342 is likely to be formed to be wider than the opening end of the gap 34 of the fourth embodiment, flowing the hot melt resin into the gap 342 can be performed more easily than flowing the hot melt resin into the gap 34. Therefore, since the hot melt resin can be reliably disposed in the gap 342, the fixing portion 352 can more reliably fix the frame 21 and the bezel 301. In addition, with such a configuration, the work efficiency of the hot melt resin disposing step (S16) is improved, so that the cost of the liquid crystal display device 112 can be reduced.

FIG. 16 illustrates an example of the bezel side wall portion 301B formed by the inner face 301B1 and an outer face 301B2 extending in parallel. The bezel side wall portion 301B only needs to be formed so that at least the inner face 301B1 thereof is formed at an angle at which the gap 342 is widened from the front side to the back side. Therefore, for example, the outer face 301B2 of the bezel side wall portion 301B may be formed not to be parallel to the inner face 301B1 but to extend in a direction orthogonal to the edge portion 301A.

As described above, in the liquid crystal display device 111, the outer face 211B2 of the frame side wall portion 211B and the inner face of the bezel side wall portion 30B face each other in an inclined manner. In the liquid crystal display device 112, the outer face of the frame side wall portion 21B and the inner face 301B1 of the bezel side wall portion 301B face each other in an inclined manner.

In the method of manufacturing the liquid crystal display device 111, in the frame preparation step (S12), the outer face 211B2 of the frame side wall portion 211B is formed so as to be inclined with respect to the main body frame portion 211A. In the method of manufacturing the liquid crystal display device 112, in the bezel preparation step (S14), the inner face 301B1 of the bezel side wall portion 301B is formed so as to be inclined with respect to the edge portion 301A.

In this case, the liquid crystal display device 111 can secure the gap 341 between the outer face 211B2 of the frame side wall portion 211B and the inner face of the bezel side wall portion 30B to further widen the region where the fixing portion 351 can be formed. The liquid crystal display device 112 can secure the gap 342 between the outer face of the frame side wall portion 21B and the inner face 301B1 of the bezel side wall portion 301B to further widen a region where the fixing portion 352 can be formed. Further, since the opening end of the gap 342 between the frame side wall portion 21B and the bezel side wall portion 301B is likely to be formed to be wider than that in the fourth embodiment, the fixing portion 352 can be easily formed between the frame side wall portion 21B and the bezel side wall portion 301B. Accordingly, since the chassis and the frame of the liquid crystal display device are more appropriately fixed by the fixing portion, the occurrence of the abnormal noise is further suppressed.

### Details of Sixth Embodiment of Present Disclosure

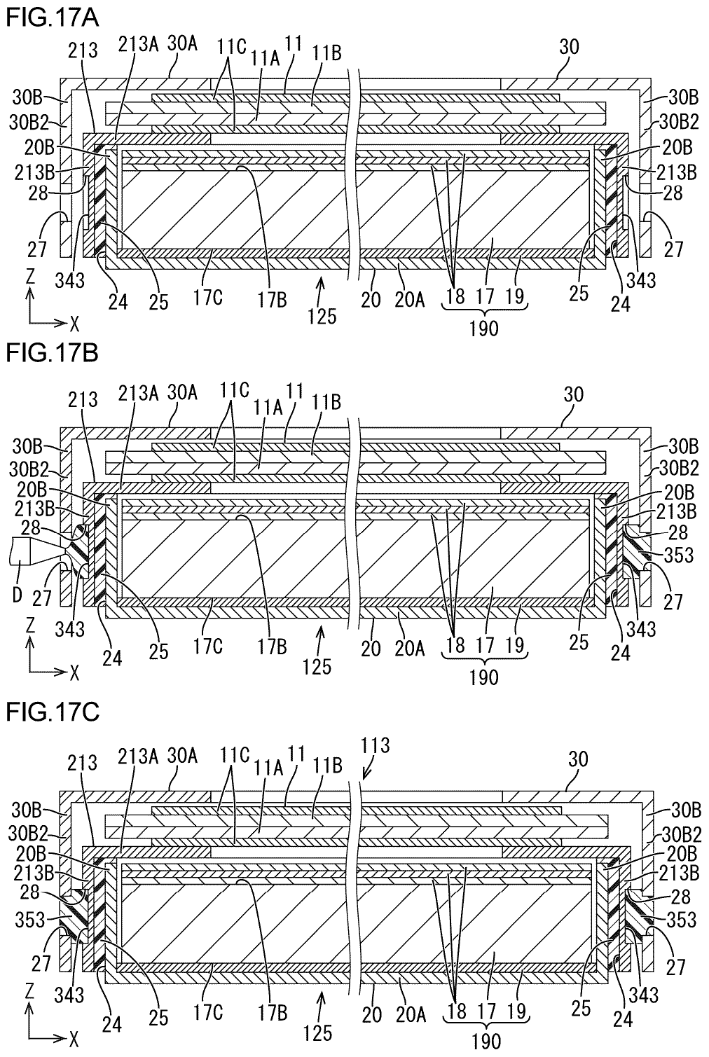

A sixth embodiment of the present disclosure will be described with reference to FIGS. 17A to 17C. In the sixth embodiment, the same reference numerals are used for the same parts as those in the fourth embodiment, and redundant description of the structure, operation, and effect will be omitted.

As illustrated in FIG. 17C, a liquid crystal display device 113 according to the sixth embodiment includes a backlight device 125 and the liquid crystal panel 11, which are integrally held by the bezel 301. The backlight device 125 includes the chassis 20 and a frame 213. The frame 213 includes a main body frame portion 213A and a frame side wall portion 213B that falls from an outer peripheral end portion of the main body frame portion 213A toward the back side and has a short tubular shape. The main body frame portion 213A is formed in the same manner as the main body frame portion 21A of the first embodiment. The frame side wall portion 213B has a second recess 28 at a position corresponding to a position where the locking portion 26 is provided in the frame side wall portion 21B of the first embodiment. The second recess 28 is a recess formed in a shape in which the frame side wall portion 213B is recessed inward. The arrangement of the second recess 28 in the circumferential direction in the frame side wall portion 213B matches the arrangement of the opening 27 in the circumferential direction in the bezel side wall portion 30B. Therefore, in a state where the liquid crystal panel 11 and the backlight device 125 covered with the bezel 30 are assembled, the second recess 28 is disposed at a position at which the second recess overlaps the opening 27 of the bezel side wall portion 30B in the portion, of the frame side wall portion 213B, disposed inside the bezel side wall portion 30B.

Between the inner face of the bezel side wall portion 30B and the outer face of the frame side wall portion 213B, a gap 343 for absorbing assembly tolerance between the bezel 30 and the frame 213 is provided. This ensures ease of assembly of the bezel 30 to the frame 213. The gap 343 also includes a space formed inside the second recess 28.

As illustrated in FIG. 17C, a fixing portion 353 is formed inside the second recess 28 that is part of the gap 343. The fixing portion 353 is provided by disposing a hot melt resin in the space inside the second recess 28 and the space between the inner face of the bezel side wall portion 30B and the outer face of the frame side wall portion 213B at the position where the second recess 28 is disposed, and the space inside the opening 27. As the hot melt resin, the resin same as that in the first embodiment is used.

The fixing portion 353 is formed in part of the gap 343, and fixes the bezel 30 and the frame 213. Thus, even when vibration acts on the liquid crystal display device 10 when rattling occurs between the bezel side wall portion 30B and the frame 213 due to assembly tolerance, a situation in which the bezel side wall portion 30B and the frame side wall portion 213B come into contact with (interfere with) each other hardly occurs. Therefore, the occurrence of abnormal noise (noise) due to the contact between the bezel side wall portion 30B and the frame side wall portion 213B is suppressed. Further, generation of foreign matter that is dust generated by part of the bezel side wall portion 30B or part of the frame side wall portion 213B being scraped due to contact between the bezel side wall portion 30B and the frame side wall portion 213B inside the liquid crystal display device 113 is also suppressed. The fixing portion 353 can be easily formed by replacing the locking portion 26 provided at the frame side wall portion 21B of the first embodiment with the second recess 28 and disposing the hot melt resin inside the second recess 28.

Next, a method of manufacturing the liquid crystal display device 113 will be described with reference to FIGS. 17A to 17C. The chassis preparation step (S11) of the method of manufacturing the liquid crystal display device 113 is similar to the chassis preparation step (S1) of the first embodiment. In the frame preparation step (S12) of the method of manufacturing the liquid crystal display device 113, the second recess 28 is formed in the frame side wall portion 213B instead of providing the locking portion 26 in the frame side wall portion 21B in the chassis preparation step (S2) of the first embodiment. Thereafter, the lighting device assembling step (S13) and the bezel preparation step (S14) are executed. Then, in the display device assembling step (S15), as illustrated in FIG. 17A, the front side of the backlight device 125 is disposed on the back side of the liquid crystal panel 11, and the bezel 30 is made to cover the front side of the liquid crystal panel 11. At this time, the bezel side wall portion 30B is disposed outside the frame side wall portion 213B in a state where the edge portion 30A of the bezel 30 overlaps a portion surrounding the display region of the liquid crystal panel 11. In this state, the gap 343, including a space inside the second recess 28, due to assembly tolerance of the bezel 30 and the frame 213 is formed between the bezel side wall portion 30B and the frame side wall portion 213B.

Next, in the hot melt resin disposing step (S16), a hot melt resin is disposed in part of the gap 343. Specifically, as illustrated in FIG. 17B, the hot melt resin is ejected from the dispenser D and poured into the second recess 28 through the opening 27 of the bezel side wall portion 30B. The operation of pouring the hot melt resin through the opening 27 of the bezel side wall portion 30B into the second recess 28 may be performed in a state where the structure in which the backlight device 125 and the liquid crystal panel 11 are integrally held by the bezel 30 is disposed on a workbench or the like so that the front side thereof faces upward. In addition, this operation may be performed in a state where the structure is disposed on a workbench or the like so that the second recess 28 is on the lower side and the opening 27 is on the upper side. That is, in the sixth embodiment, the operation of pouring the hot melt resin into the gap 343 does not need to be performed by inverting the front side and the back side of the structure. In addition, the amount of the hot melt resin poured into the gap 343 in the sixth embodiment can be smaller than the amount of the hot melt resin poured into the gap 34 in the fourth embodiment. Therefore, the operation cost and the raw material cost can be reduced.

Thereafter, as illustrated in FIG. 17C, the hot melt resin is cured to form the fixing portion 353 at positions inside the second recess 28 and inside the opening 27 in the gap 343. Thus, the liquid crystal display device 113 is completed. As described above, in the method of manufacturing the liquid crystal display device 113, the bezel 30 and the frame 213 can be fixed to each other by the fixing portion 35 with which the gap 34 between the bezel side wall portion 30B and the frame side wall portion 213B is filled. Therefore, even when the size of the gap 343 between the bezel 30 and the frame 213 varies due to assembly tolerance, occurrence of abnormal noise and generation of foreign matter at the time of vibration can be easily suppressed at low cost. In addition, by pouring the hot melt resin through the opening 27 into part of the gap 343, the fixing portion 353 can be easily and reliably formed without requiring special skill, so that the manufacturing cost of the liquid crystal display device 113 can be further reduced.

As described above, the bezel side wall portion 30B of the liquid crystal display device 113 includes the opening 27 formed to penetrate the bezel side wall portion 30B in a portion disposed outside the frame side wall portion 213B. In a state in which the liquid crystal panel 11 and the backlight device 125 covered by the bezel 30 are assembled, the second recess 28 recessed inward is formed at a position at which the second recess overlaps the opening 27 of the bezel side wall portion 30B in a portion of the frame side wall portion 213B disposed inside the bezel side wall portion 30B. The fixing portion 353 is formed so as to close the second recess 28 and the opening 27.

In the method of manufacturing the liquid crystal display device 113, the opening 27 penetrating the bezel side wall portion 30B is formed in the bezel side wall portion 30B in the bezel preparation step (S14). In the frame preparation step (S12), the second recess 28 that is recessed inward is formed at a position at which the second recess overlaps the opening 27 of the bezel side wall portion 30B in a portion, of the frame side wall portion 213B, disposed inside the bezel side wall portion 30B when the liquid crystal panel 11 is assembled to the backlight device 125 in the display device assembling step (S15). In the hot melt resin disposing step (S16), a hot melt resin is injected through the opening 27 toward the second recess 28.

The opening 27 is formed in the bezel side wall portion 30B, and the second recess 28 is formed in the frame side wall portion 213B, so that the operator can inject the hot melt resin through opening 27 toward the second recess 28. The injected hot melt resin is accumulated in the second recess 28, and the accumulated hot melt resin closes the opening 27, whereby the fixing portion 353 is formed, and the bezel 30 and the frame 213 are fixed. In this case, even when the bezel side wall portion 30B and the frame side wall portion 213B are formed to be thin, the fixing portion 353 can be formed in part of the gap 343, and the bezel 30 and the frame 213 can be fixed by the fixing portion 353. Therefore, it is possible to provide the liquid crystal display device 113 with excellent appearance in which the occurrence of the abnormal noise is suppressed and the width of the edge portion 30A of the bezel 30 is further narrowed.

### Other Embodiments

The present disclosure is not limited to the embodiments described with reference to the above description and drawings. For example, the following embodiments are also included in the technical scope of the present disclosure, and various modifications other than the following can be made without departing from the scope of the present disclosure.

(1) The backlight device used in the liquid crystal display device 10, 111, 112, 113 of the fourth embodiment to the sixth embodiment need not necessarily include the fixing portion formed of the hot melt resin in the chassis and the frame. Even in this case, since the liquid crystal display device 10, 111, 112, 113 includes the fixing portion 35, 351, 352, 353 that fixes the bezel and the frame, occurrence of abnormal noise in the liquid crystal display device 10 is suppressed, and thus occurrence of abnormal noise in the entire liquid crystal display device 10 is suppressed.

(2) The liquid crystal display device only needs to include the backlight device 12, 121, 122, 123 and the liquid crystal panel 11 that displays an image using light emitted from the backlight device 12, 121, 122, 123.

(3) The method of manufacturing a liquid crystal display device may include a step of assembling the backlight device 12, 121, 122, 123 manufactured by the method of manufacturing a backlight device of the present disclosure and the liquid crystal panel 11 that displays an image using light emitted from the backlight device 12, 121, 122, 123.

That is, the backlight device 12, 121, 122, 123 of the first embodiment to the fifth embodiment includes the fixing portion 25, 251, 252, 253 that fixes the chassis and the frame. This suppresses the occurrence of the abnormal noise in the backlight device 12, 121, 122, 123, so that the occurrence of the abnormal noise in the liquid crystal display device including the backlight device 12, 121, 122, 123 as the entire liquid crystal display device is suppressed. Therefore, the liquid crystal display device using the backlight device 12, 121, 122, 123 need not necessarily include the fixing portion that fixes the frame and the bezel. According to the liquid crystal display device having such a configuration and the method of manufacturing the liquid crystal display device, since the occurrence of the abnormal noise of the backlight device 12, 121, 122, 123 that irradiates the liquid crystal panel 11 with light is suppressed at low cost, the manufacturing cost is reduced.

(4) In the method of manufacturing the lighting device of the present disclosure, the order of the steps may be changed. For example, the frame preparation step (S2) may be executed before the chassis preparation step (S1). In addition, the hot melt resin disposing step (S4) may be executed before the lighting device assembling step (S3).

Specifically, the hot melt resin disposing step (S4) may be executed by applying a hot melt resin to the outer peripheral face of the chassis side wall portion 20B of the chassis 20 prepared in the chassis preparation step (S1). In this case, subsequently, the lighting device assembling step (S3) may be performed by assembling the chassis 20 in which the hot melt resin is applied to the outer peripheral face of the chassis side wall portion 20B, and the frame 21. In addition, the hot melt resin disposing step (S4) may be executed by applying a hot melt resin to the inner peripheral face of the frame side wall portion 21B of the frame 21 prepared in the frame preparation step (S2). In this case, thereafter, the lighting device assembling step (S3) may be performed by assembling the frame 21 in which the hot melt resin is applied to the inner peripheral face of the frame side wall portion 21B and the chassis 20.

(5) In the method of manufacturing the display device of the present disclosure, the order of the steps may be changed. For example, the bezel preparation step (S14) may be executed before the lighting device assembling step (S13). In addition, the hot melt resin disposing step (S16) may be executed before the display device assembling step (S15).

Specifically, the hot melt resin disposing step (S16) may be executed by applying the hot melt resin to the outer peripheral face of the chassis side wall portion 20B of the backlight device 12 prepared in the lighting device assembling step (S13). In this case, thereafter, the display device assembling step (S15) may be performed by assembling the frame 21 in which the hot melt resin is applied to the outer peripheral face of the frame side wall portion 21B and the bezel 30. Alternatively, the hot melt resin disposing step (S16) may be executed by applying the hot melt resin to the inner peripheral face of the bezel side wall portion 30B of the bezel 30 prepared in the bezel preparation step (S14). In this case, thereafter, the lighting device assembling step (S15) may be performed by assembling the bezel 30 in which the hot melt resin is applied to the inner peripheral face of the bezel side wall portion 30B and the frame 21 of the backlight device 12.

(6) The configuration of the sixth embodiment may be applied to the fixing portion of the backlight device 12. Specifically, in the frame preparation step (S2) of the method of manufacturing the backlight device 12, a recess similar to the second recess 28 may be provided at a position corresponding to the position where the locking portion 22 provided in the frame 21 of the backlight device 12 is provided. In this case, after the lighting device assembling step (S3) is executed, in the hot melt resin disposing step (S4), the hot melt resin may be injected through the opening 23 formed in the frame side wall portion 21B of the frame 21 toward the recess. The hot melt resin injected in this way may be accumulated in the above recess, and the accumulated hot melt resin may close the opening 23, thereby forming a fixing portion that fixes the frame 21 and the chassis 20. In this manner, the frame 21 and the chassis 20 may be fixed to each other by forming the fixing portion in part of the gap 24 between the frame side wall portion 21B and the chassis side wall portion 20B.

(7) The LEDs 15 and the LED substrate 16 need not be accommodated inside the chassis 20. For example, the chassis side wall portion 20B may not be provided at the outer peripheral end portion corresponding to one side of the outer peripheral end portion of the bottom plate portion 20A of the chassis 20, and may be configured to rise from the outer peripheral end portions corresponding to the other three sides toward the front side. The LED substrate 16 may be disposed at a portion outside the side, of the bottom plate portion of the chassis, at which the chassis side wall portion is not provided.

(8) In each of the above-described embodiments, the chassis includes the bottom plate portion and the chassis side wall portion, but the chassis may include only the chassis side wall portion surrounding the optical component 190.

(9) In addition to the above-described embodiments, the specific number and type of the optical sheets 18 included in the backlight device 12 can be appropriately changed.

(10) The reflection sheet 19 covering the opposite-to-light-emitting plate face 17C of the light guide plate 17 may be omitted.

(11) The number of the LEDs 15 mounted on the LED substrate 16 of the backlight device 12 can be appropriately changed.

(12) In each of the above embodiments, the top emission type LED is described, but a side emission type LED may be used as the light source. In addition, a light source (organic EL or the like) other than the LED may be used.

(13) In each of the above embodiments, the liquid crystal display device including the liquid crystal panel as the display panel is described, but the present invention can also be applied to a micro electro mechanical systems (MEMS) display device including a MEMS display panel as the display panel.

1. A lighting device comprising:
a chassis that is opened toward a front side and inside which a sheet-like optical component is disposed; and
a frame that covers the chassis from the front side; wherein
the chassis includes
a bottom plate portion and a chassis side wall portion rising from an outer peripheral end portion of the bottom plate portion toward the front side, wherein
the frame
includes a main body frame portion and a frame side wall portion falling from an outer peripheral end portion of the main body frame portion toward a back side, and covers the chassis from the front side, the frame side wall portion being disposed outside the chassis side wall portion in a state where the main body frame portion overlaps at least part of the optical component, wherein
the lighting device further comprises a fixing portion that is formed in part or a whole of a gap formed between the chassis side wall portion and the frame side wall portion and that fixes the chassis and the frame, and wherein
the fixing portion is formed of a hot melt resin.

2. The lighting device according to claim 1, wherein the gap between the chassis side wall portion and the frame side wall portion widens from the front side to the back side.

3. The lighting device according to claim 1, wherein a first recess that is recessed toward the front side is formed in a portion of the main body frame portion, the portion being close to a front side end portion of the chassis side wall portion.

4. A display device comprising:
the lighting device according to claim 1; and
a display panel that displays an image using light emitted from the lighting device.

5. A display device comprising:
a display panel;
a bezel covering the display panel from a front side; and
a lighting device disposed on a back side of the display panel, wherein
the bezel includes
an edge portion surrounding a display region of the display panel on the front side of the display panel, and a bezel side wall portion falling from an outer peripheral end portion of the edge portion toward the back side, wherein
the lighting device includes
a chassis that is opened toward the front side and inside which a sheet-like optical component is disposed, and a frame that covers the chassis from the front side, wherein
the frame
includes a main body frame portion and a frame side wall portion falling from an outer peripheral end portion of the main body frame portion toward the back side, and covers the chassis from the front side, the frame side wall portion being disposed outside the chassis side wall portion in a state where the main body frame portion overlaps at least part of the optical component, wherein
the bezel side wall portion is disposed outside the frame side wall portion, wherein
the lighting device further includes a fixing portion that is formed in part or a whole of a gap formed between the bezel side wall portion and the frame side wall portion and fixes the bezel and the frame, and wherein
the fixing portion is formed of a hot melt resin.

6. The display device according to claim 5, wherein a frame outer face that is an outer face of the frame side wall portion and a bezel inner face that is an inner face of the bezel side wall portion face each other in an inclined manner.

7. The display device according to claim 5, wherein
the bezel side wall portion includes
an opening formed so as to penetrate the bezel side wall portion in a portion disposed outside the frame side wall portion, wherein
in a state in which the display panel and the lighting device covered with the bezel are assembled, a second recess that is recessed inward is formed at a position at which the second recess overlaps the opening of the bezel side wall portion in a portion, of the frame side wall portion, disposed inside the bezel side wall portion, and wherein
the fixing portion is formed so as to close the second recess and the opening.

8. A method of manufacturing a lighting device, the method comprising:
a chassis preparation step of disposing a sheet-like optical component inside a chassis that is opened toward a front side, the chassis including a bottom plate portion and a chassis side wall portion rising from an outer peripheral end portion of the bottom plate portion toward the front side;
a frame preparation step of preparing a frame including a main body frame portion and a frame side wall portion falling from an outer peripheral end portion of the main body frame portion toward a back side;
a lighting device assembling step of covering the chassis with the frame from the front side so that the frame side wall portion is disposed outside the chassis side wall portion in a state where the main body frame portion overlaps at least part of the optical component; and
a hot melt resin disposing step of disposing a hot melt resin in part or a whole of a gap formed at least between the chassis side wall portion and the frame side wall portion.

9. The method according to claim 8, wherein
the frame preparation step includes performing forming so that a frame inner face that is an inner face of the frame side wall portion is inclined with respect to the main body frame portion, or the chassis preparation step includes performing forming so that a chassis outer face that is an outer face of the chassis side wall portion is inclined with respect to the bottom plate portion, and wherein
the lighting device assembling step includes performing forming so that the gap between the chassis side wall portion and the frame side wall portion widens from the front side toward the back side when the frame covers the chassis from the front side.

10. The method according to claim 8, wherein the frame preparation step includes forming a first recess recessed toward the front side in a portion of the main body frame portion, the portion being close to a front side end portion of the chassis side wall portion.

11. A method of manufacturing a display device, the method comprising a step of mounting a lighting device manufactured by the method according to claim 8 on a display panel that displays an image using light emitted from the lighting device.

12. A method of manufacturing a display device, the method comprising:
a chassis preparation step of preparing a chassis that is opened toward a front side and inside which a sheet-like optical component is disposed;
a frame preparation step of preparing a frame including a main body frame portion and a frame side wall portion falling from an outer peripheral end portion of the main body frame portion toward a back side;
a lighting device assembling step of assembling a lighting device by covering the chassis with the frame from the front side so that the frame side wall portion is disposed outside the chassis side wall portion in a state where the main body frame portion overlaps at least part of the optical component;
a bezel preparation step of preparing a bezel including an edge portion surrounding a display region of a display panel and a bezel side wall portion falling from an outer peripheral end portion of the edge portion toward the back side;
a display device assembling step of disposing the front side of the lighting device on the back side of the display panel, and assembling the display panel to the lighting device so that the bezel side wall portion is disposed outside the frame side wall portion in a state where the edge portion of the bezel overlaps a portion surrounding the display region of the display panel; and
a hot melt resin disposing step of disposing a hot melt resin in part or a whole of a gap formed at least between the bezel side wall portion and the frame side wall portion.

13. The method according to claim 12, wherein in the frame preparation step, a frame outer surface that is an outer surface of the frame side wall portion is formed to be inclined with respect to the main body frame portion, or in the bezel preparation step, a bezel inner surface that is an inner surface of the bezel side wall portion is formed to be inclined with respect to the edge portion.

14. The method according to claim 12, wherein
the bezel preparation step includes forming an opening penetrating the bezel side wall portion in the bezel side wall portion, wherein
the frame preparation step includes forming a second recess recessed inward at a position at which the second recess overlaps the opening of the bezel side wall portion in a portion, of the frame side wall portion, disposed inside the bezel side wall portion when the display panel is assembled to the lighting device in the display device assembling step, and wherein
the hot melt resin disposing step includes injecting a hot melt resin through the opening toward the second recess.
